(19) United States
(12) Patent Application Publication
(10) Pub. No.: US 2026/0024157 A1
(43) Pub. Date: Jan. 22, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventor: Shinichiro Hamada, Osaka (JP)

(21) Appl. No.: 19/341,614

(22) Filed: Sep. 26, 2025

Related U.S. Application Data
(63) Continuation of application No. PCT/JP2024/010382, filed on Mar. 15, 2024.

(30) Foreign Application Priority Data
Mar. 31, 2023 (JP) 2023-057894

(51) Int. Cl. G06Q 50/47; G06Q 10/02; G06Q 10/1093

(52) U.S. Cl. CPC G06Q 50/47; G06Q 10/02; G06Q 10/1093

(57) ABSTRACT

An information processing method to be executed by a transportation plan creation server includes acquiring, from a terminal of each of a plurality of customers who desires to be transported by a vehicle, a transportation request including customer identification information, a boarding date/time, a boarding location, and a disembark location, periodically creating, on the basis of the plurality of transportation requests, a provisional transportation plan in which the plurality of customers is allocated to a plurality of vehicles such that a predetermined constraint condition is satisfied, and outputting, at a first confirmation date/time for confirming the provisional transportation plan, travel schedule notification information for notifying a terminal of the customer allocated to the provisional transportation plan of a travel schedule from boarding to disembarking of the customer allocated to the provisional transportation plan.

### FIELD OF INVENTION

The present disclosure relates to a technique of creating a transportation plan for transporting a plurality of customers by a plurality of vehicles.

### BACKGROUND ART

Conventionally, demand-responsive transport by a bus (demand bus) is known. The demand bus receives a transportation request including a start point, an end point, a departure date/time, and the like from a plurality of customers in real time, and operates while modifying a plan for boarding and disembarking the plurality of customers in real time such that the plurality of transportation requests is satisfied.

The keyword “real-time” refers to a meaning that the transportation request occurs during a vehicle operation, and a meaning that when a transportation request is received from a new customer, a confirmed travel schedule including satisfaction of the transportation request is returned as a response at that time or within a predetermined short fixed time (for example, 5 minutes). This is known as real time dial-a-ride problem.

The demand bus is said to be a transportation service positioned intermediate between a route bus and a taxi. In the demand bus, a plurality of customers shares a vehicle like a route bus while adopting on-demand operation in which a customer can designate a start point, an end point, a departure date/time, and the like like a taxi. The fare is set to the same level as a route bus or an intermediate price range between a route bus and a taxi.

That is, characteristics of a demand bus service are demand operation, vehicle sharing, and low fare. The operation according to the transportation request increases transportation efficiency. Sharing a vehicle by a plurality of customers increases the transportation efficiency. As a customer return for improvement of the transportation efficiency, the fare can be suppressed at low cost.

In order to expand the application range of the demand bus, it is necessary to provide a service mechanism in which vehicle sharing is performed to such an extent that the profitability of transportation can be secured even with a low density of occurrence of transportation requests.

In a ride-sharing service which is a transportation service different from the demand bus service, a mechanism for enhancing vehicle sharing has been conventionally proposed (see, for example, Patent Literatures 1 and 2.).

Note that the ride-sharing service is a service for matching a driver who provides a vehicle and a fellow passenger who wants to share the vehicle.

However, since the ride-sharing service is assumed as an application destination of the conventional technique, the execution of transportation is determined, and a method for improving the vehicle sharing is proposed. Therefore, conventionally, a method for securing the profitability of transportation has not been considered, and further improvement has been required.

Patent Literature 1: JP 2020-13345 A

Patent Literature 2: JP 2021-89478 A

### SUMMARY OF THE INVENTION

The present disclosure has been made to solve the above problems, and an object of the present disclosure is to provide a technique that can create a transportation plan capable of securing profitability of transportation.

An information processing method of the present disclosure is an information processing method in a computer that creates a transportation plan for transporting a plurality of customers by a plurality of vehicles, the method including acquiring, from a terminal of each of the plurality of customers who desires to be transported by a vehicle, a transportation request including customer identification information, a boarding date/time, a boarding location, and a disembark location, periodically creating, on a basis of the plurality of transportation requests, a provisional transportation plan in which the plurality of customers is allocated to the plurality of vehicles such that a predetermined constraint condition is satisfied, and outputting, at a first confirmation date/time for confirming the provisional transportation plan, travel schedule notification information for notifying a terminal of the customer allocated to the provisional transportation plan of a travel schedule from boarding to disembarking of the customer allocated to the provisional transportation plan.

The present disclosure can create a transportation plan capable of securing profitability of transportation.

### BRIEF DESCRIPTION OF THE DRAWINGS

FIG. 1 is a diagram illustrating an overall configuration of a vehicle dispatch management system in a first embodiment of the present disclosure.

FIG. 2 is a diagram illustrating an example of bus stop timetable data in the first embodiment.

FIG. 3 is a diagram illustrating an example of inter-bus stop distance table data in the first embodiment.

FIG. 4 is a diagram illustrating an example of vehicle definition data in the first embodiment.

FIG. 5 is a diagram illustrating an example of occupant number constraint data in the first embodiment.

FIG. 6 is a diagram illustrating an example of detour degree constraint data in the first embodiment.

FIG. 7 is a schematic diagram for describing an operation from when a transportation plan creation server receives transportation request data to when the transportation plan creation server transmits travel schedule notification information in the first embodiment.

FIG. 8 is a flowchart for describing an operation of a transportation request receiver of the transportation plan creation server in the first embodiment of the present disclosure.

FIG. 9 is a first flowchart for describing an operation of a transportation plan creator of the transportation plan creation server in the first embodiment of the present disclosure.

FIG. 10 is a second flowchart for describing the operation of the transportation plan creator of the transportation plan creation server in the first embodiment of the present disclosure.

FIG. 11 is a third flowchart for describing the operation of the transportation plan creator of the transportation plan creation server in the first embodiment of the present disclosure.

FIG. 12 is a fourth flowchart for describing the operation of the transportation plan creator of the transportation plan creation server in the first embodiment of the present disclosure.

FIG. 13 is a schematic diagram for describing processing of creating an initial solution of a provisional transportation plan by an initial solution creator in the first embodiment.

FIG. 14 is a schematic diagram for describing processing of creating a hypothesis solution of a provisional transportation plan by an improved solution creator in the first embodiment.

FIG. 15 is a flowchart for describing solution evaluation processing of the transportation plan creation server in the first embodiment.

FIG. 16 is a flowchart for describing an operation of a transmitter of the transportation plan creation server in the first embodiment of the present disclosure.

FIG. 17 is a diagram illustrating an example of a transportation request input screen displayed on a customer terminal in the first embodiment.

FIG. 18 is a diagram illustrating an example of an adoption notification screen displayed on the customer terminal in the first embodiment.

FIG. 19 is a diagram illustrating an example of a rejection notification screen displayed on the customer terminal in the first embodiment.

FIG. 20 is a diagram illustrating an example of a travel schedule notification screen displayed on the customer terminal in the first embodiment.

FIG. 21 is a diagram illustrating an example of a first message screen displayed on the customer terminal in the first embodiment.

FIG. 22 is a diagram illustrating an example of a second message screen displayed on the customer terminal in the first embodiment.

FIG. 23 is a diagram illustrating an overall configuration of a vehicle dispatch management system in a second embodiment of the present disclosure.

FIG. 24 is a diagram illustrating an example of a plurality of pieces of subarea definition data in the second embodiment.

FIG. 25 is a flowchart for describing an operation of a transportation request receiver of a transportation plan creation server in the second embodiment of the present disclosure.

### DETAILED DESCRIPTION

### Knowledge Underlying Present Disclosure

A demand bus service has a structural problem. Normally, an introduction of the demand bus is often considered in an area with a relatively low density of occurrence of transportation requests. This is because the operation method of the route bus is more efficient than the demand operation method in an area with a high density of occurrence of transportation requests.

On the other hand, when the density of occurrence of transportation requests is excessively low, vehicle sharing is not established. In this case, although the transportation service has essentially the same operation status as a taxi, a vehicle larger than a taxi is operated at a lower fare than a taxi. In this case, it may be difficult to continue the business because the profitability is not satisfactory.

In summary, the demand bus service is established only after all of demand operation, vehicle sharing, and low fare work effectively. However, from the viewpoint of demand operation, a region having a low density of occurrence of transport requests is adapted, and from the viewpoint of vehicle sharing, an area with a high density of occurrence of transportation requests is adapted. In view of the above, the demand bus is adapted to an area with a medium density of occurrence of transportation requests, but such an area is limited.

Since the ride-sharing service is assumed as an application destination of the conventional technique, the execution of transportation of a customer whose transportation request has been accepted is determined, and a method for improving the vehicle sharing is proposed. Therefore, conventionally, a method for securing the profitability of transportation has not been considered. In particular, while the conventional technique creates a transportation plan covering all the accepted transportation requests, the present technique determines the transportation plan once all the transportation requests are accepted.

In order to solve the above problem, the following technique is disclosed.
(1) An information processing method according to an aspect of the present disclosure is an information processing method in a computer that creates a transportation plan for transporting a plurality of customers by a plurality of vehicles, the method including acquiring, from a terminal of each of the plurality of customers who desires to be transported by a vehicle, a transportation request including customer identification information, a boarding date/time, a boarding location, and a disembark location, periodically creating, on a basis of the plurality of transportation requests, a provisional transportation plan in which the plurality of customers is allocated to the plurality of vehicles such that a predetermined constraint condition is satisfied, and outputting, at a first confirmation date/time for confirming the provisional transportation plan, travel schedule notification information for notifying a terminal of the customer allocated to the provisional transportation plan of a travel schedule from boarding to disembarking of the customer allocated to the provisional transportation plan.

In this configuration, the provisional transportation plan in which the plurality of customers is allocated to the plurality of vehicles such that the predetermined constraint conditions is satisfied is periodically created on the basis of the plurality of transportation requests until the first confirmation date/time for confirming the provisional transportation plan. Therefore, even in an area with little transportation demand, it is possible to acquire transportation requests from more customers and allocate more customers to a plurality of vehicles, and it is thus possible to create a transportation plan capable of securing the profitability of transportation.
(2) The information processing method according to (1) may further include at a second confirmation date/time for confirming that transportation is impossible, outputting rejection notification information for notifying that transportation is impossible to the terminal of the customer not allocated to the provisional transportation plan.

This configuration can notify the customer in advance that transportation is impossible.
(3) In the information processing method according to (1), the predetermined constraint condition may include that a number of occupants of each of the plurality of vehicles is equal to or larger than a lower limit value.

This configuration can more reliably secure the profitability of transportation because the provisional transportation plan is created such that the number of occupants of each of the plurality of vehicles is equal to or larger than the lower limit value.
(4) In the information processing method according to (3), the lower limit value may increase as a transportation distance or a transportation time increases.

In this configuration, the provisional transportation plan is created such that the number of occupants of each of the plurality of vehicles increases as the transportation distance or the transportation time increases. Therefore, when the transportation fare of the vehicle is a fixed price, even if the transportation distance or the transportation time increases, the profitability of transportation can be secured.
(5) In the information processing method according to (3), the lower limit value may be a fixed number of people, and a transportation fare of the vehicle increases as the transportation distance or the transportation time increases.

In this configuration, since the transportation fare of the vehicle increases as the transportation distance or the transportation time increases, even if the transportation distance or the transportation time increases when the number of occupants is small, the profitability of transportation can be secured.
(6) In the information processing method according to any one of (1) to (5), the predetermined constraint condition may include that a ratio of a total time of individual transportation time for individually transporting a plurality of customers allocated to one vehicle among the plurality of vehicles and an overall transportation time from when the plurality of customers allocated to the one vehicle is first boarded to when the plurality of customers is finally disembarked is equal to or less than a threshold.

In this configuration, the provisional transportation plan is created such that the ratio between the total time of the individual transportation time for individually transporting the plurality of customers allocated to one vehicle among the plurality of vehicles and the overall transportation time from when the plurality of customers allocated to the one vehicle is first boarded to when the plurality of customers is finally disembarked is equal to or less than the threshold, and it is therefore possible to secure the efficiency of transportation together with the profitability of transportation.
(7) The information processing method according to any one of (1) to (6) may further include, when the provisional transportation plan is created, outputting the adoption notification information for notifying the terminal of each of the plurality of customers allocated to the provisional transportation plan that transportation is possible.

This configuration can notify the customer in advance that transportation is possible.
(8) The information processing method according to (7) may further include outputting first standby notification information for notifying that a standby time until it is determined whether transportation is possible occurs between acquisition of the transportation request and output of the adoption notification information.

This configuration outputs the first standby notification information for notifying that a standby time until it is determined whether transportation is possible occurs between the acquisition of the transportation request and the output of the adoption notification information.

Therefore, it is possible to notify the customer that the standby time occurs between the transmission of the transportation request and the reception of the adoption notification information.
(9) The information processing method according to (7) or (8) may further include outputting second standby notification information for notifying that a standby time until the travel schedule is determined occurs between output of the adoption notification information and output of the travel schedule notification information.

This configuration can notify the customer that the standby time occurs between the reception of the adoption notification information and the reception of the travel schedule notification information.
(10) The information processing method according to (2) may further include outputting first standby notification information for notifying that a standby time until it is determined whether transportation is possible occurs between acquisition of the transportation request and output of the rejection notification information.

This configuration outputs the first standby notification information for notifying that a standby time until it is determined whether transportation is possible occurs between the acquisition of the transportation request and the output of the rejection notification information.

Therefore, it is possible to notify the customer that the standby time occurs between the transmission of the transportation request and the reception of the rejection notification information.
(11) In the information processing method according to any one of (1) to (10), an area in which the plurality of vehicles transports may be divided into at least one subarea, the at least one subarea may be classified into a first subarea in which a density of occurrence of transportation requests is higher than a threshold and a second subarea in which the density of occurrence of transportation requests is lower than the threshold, in a case where any one or both of the boarding location and the disembark location included in one transportation request among the plurality of transportation requests are in the first subarea, a transportation plan in which a customer of the one transportation request is allocated to one vehicle may be further immediately created on a basis of the one transportation request, the travel schedule notification information may further output to the terminal of the customer allocated to the transportation plan created, and in the creating of the provisional transportation plan, in a case where any one or both of the boarding location and the disembark location included in the one transportation request are in the second subarea, the provisional transportation plan in which the customer of the one transportation request is allocated to the plurality of vehicles may be created on a basis of the one transportation request such that the predetermined constraint condition is satisfied.

The number of customers who desire to be transported in the first subarea in which the density of occurrence of transportation requests is higher than the threshold is larger than the number of customers who desire to be transported in the second subarea in which the density of occurrence of transportation requests is lower than the threshold. Therefore, in a case where any one or both of the boarding location and the disembark location included in one transportation request are in the first subarea with high transportation demand, even if a transportation plan in which the customer of one transportation request is allocated to one vehicle is immediately created, it is possible to create a transportation plan capable of sufficiently securing the profitability of transportation. On the other hand, in a case where any one or both of the boarding location and the disembark location included in one transportation request are in the second subarea with little transportation demand, it is possible to create a transportation plan capable of securing the profitability of transportation by acquiring transportation requests from more customers and allocating more customers to a plurality of vehicles over a certain period of time.
(12) In the information processing method according to (11), a number of divisions and a size of the at least one subarea may vary depending on a time period.

This configuration can create a transportation plan capable of more reliably securing the profitability of transportation in accordance with the density of occurrence of transportation requests that changes in accordance with the time period.

The present disclosure can be implemented not only as an information processing method for executing the characteristic processing as described above, but also as an information processing device or the like having a characteristic configuration corresponding to characteristic processing executed by the information processing method. The present disclosure can also be implemented as a computer program that causes a computer to execute characteristic processing included in the information processing method described above. Therefore, an effect similar to the effect in the above information processing method can also be achieved by another aspect described below.
(13) An information processing device according to another aspect of the present disclosure is an information processing device that creates a transportation plan for transporting a plurality of customers by a plurality of vehicles, the device including an acquisition part that acquires, from a terminal of each of the plurality of customers who desires to be transported by a vehicle, a transportation request including customer identification information, a boarding date/time, a boarding location, and a disembark location, a creator that periodically creates, on a basis of the plurality of transportation requests, a provisional transportation plan in which the plurality of customers is allocated to the plurality of vehicles such that a predetermined constraint condition is satisfied, and an output part that outputs, at a first confirmation date/time for confirming the provisional transportation plan, travel schedule notification information for notifying a terminal of the customer allocated to the provisional transportation plan of a travel schedule from boarding to disembarking of the customer allocated to the provisional transportation plan.
(14) An information processing program according to another aspect of the present disclosure is an information processing program that creates a transportation plan for transporting a plurality of customers by a plurality of vehicles, the program causing a computer to function to acquire, from a terminal of each of the plurality of customers who desires to be transported by a vehicle, a transportation request including customer identification information, a boarding date/time, a boarding location, and a disembark location, periodically create, on a basis of the plurality of transportation requests, a provisional transportation plan in which the plurality of customers is allocated to the plurality of vehicles such that a predetermined constraint condition is satisfied, and output, at a first confirmation date/time for confirming the provisional transportation plan, travel schedule notification information for notifying the terminal of the customer allocated to the provisional transportation plan of a travel schedule from boarding to disembarking of the customer allocated to the provisional transportation plan.
(15) A non-transitory computer-readable recording medium according to another aspect of the present disclosure records an information processing program that creates a transportation plan for transporting a plurality of customers by a plurality of vehicles, the information processing program causing a computer to function to acquire, from a terminal of each of the plurality of customers who desires to be transported by a vehicle, a transportation request including customer identification information, a boarding date/time, a boarding location, and a disembark location, periodically create, on a basis of the plurality of transportation requests, a provisional transportation plan in which the plurality of customers is allocated to the plurality of vehicles such that a predetermined constraint condition is satisfied, and output, at a first confirmation date/time for confirming the provisional transportation plan, travel schedule notification information for notifying the terminal of the customer allocated to the provisional transportation plan of a travel schedule from boarding to disembarking of the customer allocated to the provisional transportation plan.

Hereinafter, embodiments of the present disclosure will be described with reference to the accompanying drawings. Each of embodiments described below illustrates a specific example of the present disclosure. Numerical values, shapes, constituent elements, steps, order of steps, and the like of the embodiment below are merely examples, and do not intend to limit the present disclosure. A constituent element not described in an independent claim representing a highest concept among constituent elements in the embodiments below is described as an optional constituent element. In all the embodiments, respective contents can be combined.

### First Embodiment

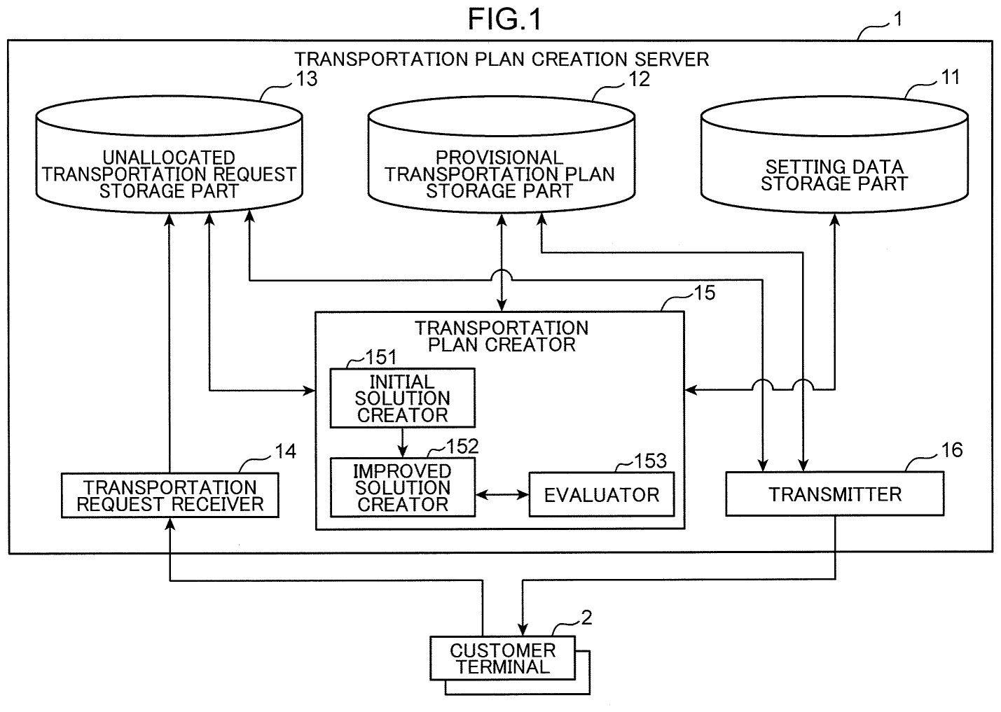

FIG. 1 is a diagram illustrating an overall configuration of a vehicle dispatch management system in a first embodiment of the present disclosure.

The vehicle dispatch management system illustrated in FIG. 1 includes a transportation plan creation server 1 and a plurality of customer terminals 2.

The customer terminal 2 is a smartphone, a tablet computer, or a personal computer, for example, and is carried by a customer who desires to be transported by a vehicle. The vehicle is, for example, a bus that transports a plurality of persons. The customer terminal 2 receives an input of a boarding location, a disembark location, and a boarding date/time by the customer, and transmits transportation request data including a customer ID, the boarding location, the disembark location, and the boarding date/time to the transportation plan creation server 1. The customer ID is customer identification information for identifying a customer, and is stored in advance in a memory of the customer terminal 2. The basic configuration of each of the plurality of customer terminals 2 is the same.

In the first embodiment, an operation route and a stop place (bus stop) of the vehicle are determined in advance. The customer selects a boarding location and a disembark location from a plurality of stop places set in advance on the operation route. The customer inputs the date and time of boarding the vehicle.

In the first embodiment, the boarding location and the disembark location are predetermined stop places (bus stops). However, the present disclosure is not limited to the places, and the boarding location and the disembark location may be arbitrary places specified by the customer. In this case, the customer may input the boarding location and the disembark location on a map displayed on the customer terminal 2, or may input an address, a facility name, or the like as the boarding location and the disembark location to the customer terminal 2.

The customer terminal 2 may receive adoption notification information for notifying that the transportation is possible from the transportation plan creation server 1, and display the received adoption notification information. The customer terminal 2 may receive, from the transportation plan creation server 1, first standby notification information for notifying that a standby time until it is determined whether transportation is possible occurs between the acquisition of the transportation request data and the reception of the adoption notification information, and display the received first standby notification information.

The customer terminal 2 may receive travel schedule notification information for notifying a travel schedule from boarding to disembarking of the customer from the transportation plan creation server 1, and display the received travel schedule notification information. The customer terminal 2 may receive, from the transportation plan creation server 1, second standby notification information for notifying that the standby time until the travel schedule is determined is to occur between the reception of the adoption notification information and the reception of the travel schedule notification information, and display the received second standby notification information. The customer terminal 2 may receive rejection notification information for notifying that the transportation is impossible from the transportation plan creation server 1, and display the received rejection notification information.

The transportation plan creation server 1 creates a transportation plan for transporting a plurality of customers by a plurality of vehicles. The transportation plan creation server 1 is communicably connected to the plurality of customer terminals 2 via a network. The network is the Internet, for example.

The transportation plan creation server 1 includes a setting data storage part 11, a provisional transportation plan storage part 12, an unallocated transportation request storage part 13, a transportation request receiver 14, a transportation plan creator 15, and a transmitter 16.

The transportation plan creator 15 is implemented by a processor. The processor includes, for example, a central processing unit (CPU) or the like.

The setting data storage part 11, the provisional transportation plan storage part 12, and the unallocated transportation request storage part 13 are implemented by a memory. The memory includes, for example, a read only memory (ROM), an electrically erasable programmable read only memory (EEPROM), or the like.

The transportation request receiver 14 and the transmitter 16 are implemented by a communication module.

The setting data storage part 11 stores in advance bus stop timetable data, inter-bus stop distance table data, vehicle definition data, occupant number constraint data, and detour degree constraint data.

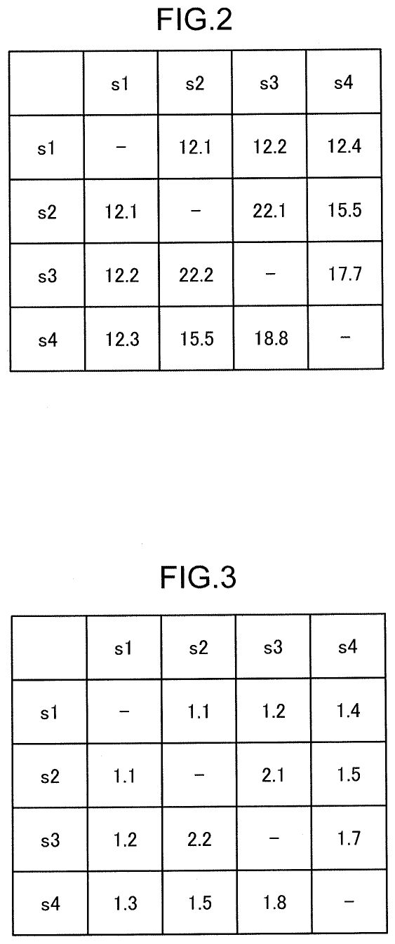

FIG. 2 is a diagram illustrating an example of bus stop timetable data in the first embodiment.

The bus stop timetable data is data indicating time required for movement between bus stops. In the bus stop timetable data, the vertical axis represents bus stops s1, s2, s3, and s4 as movement sources, and the horizontal axis represents the bus stops s1, s2, s3, and s4 as movement destinations. The unit is, for example, a minute. The bus stop timetable data does not become a symmetric matrix due to the presence of one-way traffic, a difference in traffic volume, or the like. In the bus stop timetable data in the first embodiment, a fixed value is used regardless of a time period, a season, or the like, but a different value may be used for each time period or each season.

FIG. 3 is a diagram illustrating an example of inter-bus stop distance table data in the first embodiment.

The inter-bus stop distance table data is data indicating a distance of a movement route between bus stops. In the inter-bus stop distance table data, the vertical axis represents the bus stops s1, s2, s3, and s4 as movement sources, and the horizontal axis represents the bus stops s1, s2, s3, and s4 as movement destinations. The unit is, for example, kilometers. The inter-bus stop distance table data does not become a symmetric matrix due to the presence of one-way traffic or the like. In the inter-bus stop distance table data in the first embodiment, a fixed value is used regardless of a time period, a season, or the like, but a different value may be used for each time period or each season.

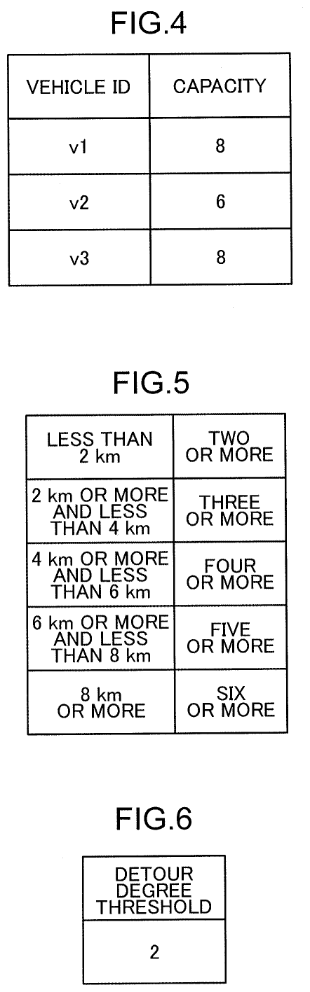

FIG. 4 is a diagram illustrating an example of vehicle definition data in the first embodiment.

The vehicle definition data is data indicating a plurality of vehicle IDs for identifying a plurality of vehicles and a capacity of each vehicle. As illustrated in FIG. 4, in the first embodiment, the vehicle definition data includes three vehicle IDs of a first vehicle v1, a second vehicle v2, and a third vehicle v3. The vehicle definition data indicates that the capacity of the first vehicle v1 is eight, the capacity of the second vehicle v2 is six, and the capacity of the third vehicle v3 is eight.

FIG. 5 is a diagram illustrating an example of occupant number constraint data in the first embodiment.

The occupant number constraint data is data indicating a lower limit value of the number of occupants in an individual transportation plan. The constraint condition of the number of occupants is used to secure profitability of transportation. In the first embodiment, a lower limit value varies depending on a total transportation distance of the individual transportation plan, and increases as the total transportation distance increases. For example, when the total transportation distance is less than 2 km, the lower limit value is two, when the total transportation distance is 2 km or more and less than 4 km, the lower limit value is three, when the total transportation distance is 4 km or more and less than 6 km, the lower limit value is four, when the total transportation distance is 6 km or more and less than 8 km, the lower limit value is five, and when the total transportation distance is 8 km or more, the lower limit value is six. The lower limit value may vary depending on a total transportation time of the individual transportation plan, and increase as the total transportation time increases. For example, the lower limit value in an off time period may be a value that relaxes the occupant number constraint.

The individual transportation plan indicates an order of transportation in which boarding actions and disembark actions of a plurality of customers allocated to individual vehicles are arranged in time series. The individual transportation plan includes a scheduled boarding date/time and a scheduled disembark date/time of each customer. The transportation plan indicates a set of individual transportation plans.

FIG. 6 is a diagram illustrating an example of detour degree constraint data in the first embodiment.

The detour degree constraint data is data indicating a threshold of a detour degree of the individual transportation plan. The detour degree in the first embodiment is an index for securing transportation efficiency, and is an index for preventing customers heading in different directions from being allocated to the same transportation plan. Note that the threshold may be different depending on the time period. For example, the threshold value in an off time period may be a value that relaxes the detour degree constraint.

The transportation request receiver 14 acquires transportation request data including the customer ID, the boarding date/time, the boarding location, and the disembark location from the customer terminal 2 of each of a plurality of customers who desires to be transported by the vehicle. The transportation request receiver 14 receives the transportation request data transmitted by the customer terminal 2. The transportation request receiver 14 stores the received transportation request data in the unallocated transportation request storage part 13.

The unallocated transportation request storage part 13 stores transportation request data of a customer not allocated to the provisional transportation plan.

The transportation plan creator 15 periodically creates a provisional transportation plan in which a plurality of customers is allocated to a plurality of vehicles such that a predetermined constraint condition is satisfied on the basis of a plurality of sets of transportation request data. The transportation plan creator 15 stores the created provisional transportation plan in the provisional transportation plan storage part 12. The transportation plan creator 15 periodically and repeatedly creates the provisional transportation plan until a first confirmation date/time for confirming the provisional transportation plan. The first confirmation date/time is a date and time a first time before the boarding date/time of a first customer allocated to the provisional transportation plan. The first time is twelve hours, for example. The transportation plan creator 15 periodically creates the provisional transportation plan so that a predetermined constraint condition is satisfied on the basis of the transportation request data stored in the unallocated transportation request storage part 13 and the provisional transportation plan stored in the provisional transportation plan storage part 12 until the first confirmation date/time.

The predetermined constraint condition includes a first constraint condition that the number of occupants of each of the plurality of vehicles is equal to or larger than the lower limit value. The lower limit value increases as the transportation distance or the transportation time increases. The lower limit value is defined in advance in the occupant number constraint data stored in the setting data storage part 11.

In the first embodiment, the lower limit value of the transportation plan participant is set in accordance with the distance because the transportation service adopts a fixed fare. This is because the management damage in a case where the vehicle with a fixed transportation fare is operated with a small number of people increases as the distance increases. The lower limit value is a fixed number of people, and the transportation fare of the vehicle may increase as the transportation distance or the transportation time increases. The lower limit value may be set in accordance with the transportation time instead of the transportation distance.

The predetermined constraint condition includes a second constraint condition that a ratio of a total time of individual transportation time for individually transporting a plurality of customers allocated to one vehicle among the plurality of vehicles to an overall transportation time from when the plurality of customers allocated to the one vehicle is first boarded to when the plurality of customers is finally disembarked is equal to or less than a threshold. The threshold is defined in advance in the detour degree constraint data stored in the setting data storage part 11.

The transportation plan creator 15 calculates, as the detour degree, a ratio between a total time of individual transportation time for individually transporting a plurality of customers allocated to one vehicle among a plurality of vehicles included in the transportation plan and an overall transportation time from when a plurality of customers allocated to the one vehicle is first boarded to when the plurality of customers are finally disembarked. The detour degree is a value obtained by dividing the overall transportation time from when a plurality of customers allocated to one vehicle among a plurality of vehicles included in the transportation plan is first boarded to when the plurality of customers is finally disembarked by the total time of the individual transportation time for individually transporting the plurality of customers allocated to the one vehicle.

The detour degree in the first embodiment is represented by the following equation (1).

$$Detour ( tour ) = T T ( tour ) / \sum pax ∈ tour T P ( pax ) \qquad ( 1 )$$

In the above equation (1), Detour (tour) represents the detour degree, TT (tour) represents the total transportation time of a transportation plan “tour”, and TP (pax) represents each transportation time in a case where a customer pax is individually transported.

The detour degree is an index value indicating how efficient the transportation plan is. As the value of the detour degree increases, the transportation efficiency deteriorates. When the threshold is set to, for example, 0.7, up to 0.7 times the sum of the transportation time for individually transporting each customer is an allowable range of the total transportation time of the transportation plan. In the second constraint condition, a ratio is used, but a difference may be used. The transportation distance may be used instead of the transportation time.

In the first embodiment, the transportation plan creator 15 periodically creates the provisional transportation plan so that both the first constraint condition and the second constraint condition are satisfied, but the present disclosure is not limited thereto. The provisional transportation plan may be periodically created so that only the first constraint condition is satisfied, or the provisional transportation plan may be periodically created so that only the second constraint condition is satisfied.

The provisional transportation plan storage part 12 stores the provisional transportation plan created by the transportation plan creator 15.

The transportation plan creator 15 includes an initial solution creator 151, an improved solution creator 152, and an evaluator 153.

The initial solution creator 151 allocates a plurality of customers to the vehicle in an uppermost row in the vehicle definition data until the vehicle is full. When the vehicle in the uppermost row is full, the initial solution creator 151 allocates the remaining customers to the vehicle in the next row in the vehicle definition data. The initial solution creator 151 creates, as an initial solution, a provisional transportation plan for boarding and disembarking the customers allocated to each vehicle in the allocated order.

Specifically, the initial solution creator 151 acquires a transportation request data group stored in the unallocated transportation request storage part 13, the provisional transportation plan stored in the provisional transportation plan storage part 12, and the vehicle definition data stored in the setting data storage part 11. The initial solution creator 151 creates an initial solution of the provisional transportation plan on the basis of the acquired transportation request data group, provisional transportation plan, and vehicle definition data.

The improved solution creator 152 improves the initial solution of the provisional transportation plan by a procedure derived from a ruin and recreate method, which is a type of delivery plan sub-optimization algorithm. The ruin and recreate method is disclosed in, for example, a conventional literature (Gerhard Schrimpf, Johannes Schneider, Hermann Stamm-Wilbrandt, and Gunter Dueck, “Record Breaking Optimization Results Using the Ruin and Recreate Principles”, Journal of Computational Physics 159, 2000, 139-171).

When an effective customer set after improvement is a superset of the effective customer set before improvement, the improved solution creator 152 updates the solution. Note that the effective customer set is a set of customers included in the individual transportation plan that satisfies the first constraint condition and the second constraint condition in the provisional transportation plan. The improved solution creator 152 extracts an individual transportation plan that satisfies the first constraint condition and the second constraint condition from the solution, increases the number of vehicles, and continues to improve the solution.

Specifically, the improved solution creator 152 acquires an initial solution of the provisional transportation plan created by the initial solution creator 151. The improved solution creator 152 outputs the initial solution of the acquired provisional transportation plan to the evaluator 153, and acquires an evaluation value of the initial solution from the evaluator 153.

The improved solution creator 152 stores the acquired initial solution of the provisional transportation plan and the evaluation value of the initial solution in the memory as a current solution of the provisional transportation plan and an evaluation value of the current solution. The improved solution creator 152 creates a hypothesis solution of the provisional transportation plan obtained by copying the current solution of the provisional transportation plan and the evaluation value of the current solution, and creates an evaluation value of the hypothesis solution. The improved solution creator 152 extracts boarding actions and disembark actions of a predetermined number of customer groups from the hypothesis solution of the provisional transportation plan, and creates a hypothesis solution candidate group in which a pair of the boarding action and the disembark action of the extracted customer group is inserted into a plurality of points of the hypothesis solution.

The improved solution creator 152 outputs the hypothesis solution candidate group to the evaluator 153, and acquires an evaluation value of each of the hypothesis solution candidate groups from the evaluator 153. The improved solution creator 152 stores the hypothesis solution candidate having a minimum evaluation value and an evaluation value of the hypothesis solution candidate in the memory as the hypothesis solution of the provisional transportation plan and the evaluation value of the hypothesis solution. The improved solution creator 152 determines whether the hypothesis solution of the provisional transportation plan satisfies the first constraint condition and the second constraint condition, and stores the hypothesis solution of the provisional transportation plan and the evaluation value of the hypothesis solution in the memory as the current solution of the provisional transportation plan and the evaluation value of the current solution in a case where the hypothesis solution of the provisional transportation plan satisfies the first constraint condition and the second constraint condition.

The improved solution creator 152 creates an optimal solution of the provisional transportation plan by repeatedly creating a hypothesis solution of the provisional transportation plan and updating the current solution a predetermined number of times. The improved solution creator 152 repeatedly creates the hypothesis solution of the provisional transportation plan and updates the current solution a predetermined number of times, and then overwrites the provisional transportation plan storage part 12 with the individual transportation plan satisfying the first constraint condition and the second constraint condition among the current solutions as the provisional transportation plan. The improved solution creator 152 repeatedly creates the hypothesis solution of the provisional transportation plan and updates the current solution a predetermined number of times, and then overwrites the unallocated transportation request storage part 13 with the transportation request data of the customer included in the individual transportation plan that does not satisfy the first constraint condition and the second constraint condition among the current solutions.

The evaluator 153 acquires an initial solution or a hypothesis solution candidate of the provisional transportation plan from the improved solution creator 152. The evaluator 153 calculates a total value of the transportation time of all the plurality of vehicles in the initial solution or the hypothesis solution candidate of the provisional transportation plan. The evaluator 153 calculates a total value of delay time of the scheduled boarding date/time from the boarding date/time of the transportation request data of the plurality of customers in the initial solution or the hypothesis solution candidate of the provisional transportation plan. The evaluator 153 calculates a total value of the total value of the transportation time and the total value of the delay time as an evaluation value. Specifically, the evaluator 153 calculates the evaluation value on the basis of the following equation (2).

$$Evaluation value = \sum \_v ∈ V F 1 ( v ) + α * F 2 ( v ) \qquad ( 2 )$$

In the above equation (2), F1(v) represents the total value of the transportation time of the vehicle v, F2(v) represents the total value of the delay time of the scheduled boarding date/time from the boarding date/time of the transportation request data of the vehicle v, and V represents a set of vehicles included in the solution of the provisional transportation plan. A coefficient α is a predetermined value and is a real number of 0 or more.

The evaluator 153 outputs the calculated evaluation value of the initial solution or the hypothesis solution candidate of the provisional transportation plan to the improved solution creator 152.

The transmitter 16 outputs the travel schedule notification information for notifying the customer terminal 2 of the customer allocated to the provisional transportation plan of the travel schedule from the boarding to the disembarking of the customer allocated to the provisional transportation plan at the first confirmation date/time for confirming the provisional transportation plan. The transmitter 16 transmits the travel schedule notification information to the customer terminal 2 of the customer allocated to the provisional transportation plan stored in the provisional transportation plan storage part 12 at the first confirmation date/time.

At the second confirmation date/time for confirming that transportation is impossible, the transmitter 16 outputs rejection notification information for notifying that transportation is impossible to the customer terminal 2 of a customer not allocated to the provisional transportation plan. The second confirmation date/time is a date and time a second time before the boarding date/time of the customer not allocated to the provisional transportation plan. The second time is twelve hours, for example. The transmitter 16 transmits the rejection notification information to the customer terminal 2 of the customer not allocated to the provisional transportation plan stored in the unallocated transportation request storage part 13 at the second confirmation date/time.

The first time and the second time may be the same as or different from each other.

When the provisional transportation plan is created by the transportation plan creator 15, the transmitter 16 outputs the adoption notification information for notifying the customer terminals 2 of the plurality of customers allocated to the provisional transportation plan that transportation is possible. When the provisional transportation plan is created by the transportation plan creator 15, the transmitter 16 transmits the adoption notification information to the customer terminal 2 of the customer allocated to the provisional transportation plan stored in the provisional transportation plan storage part 12.

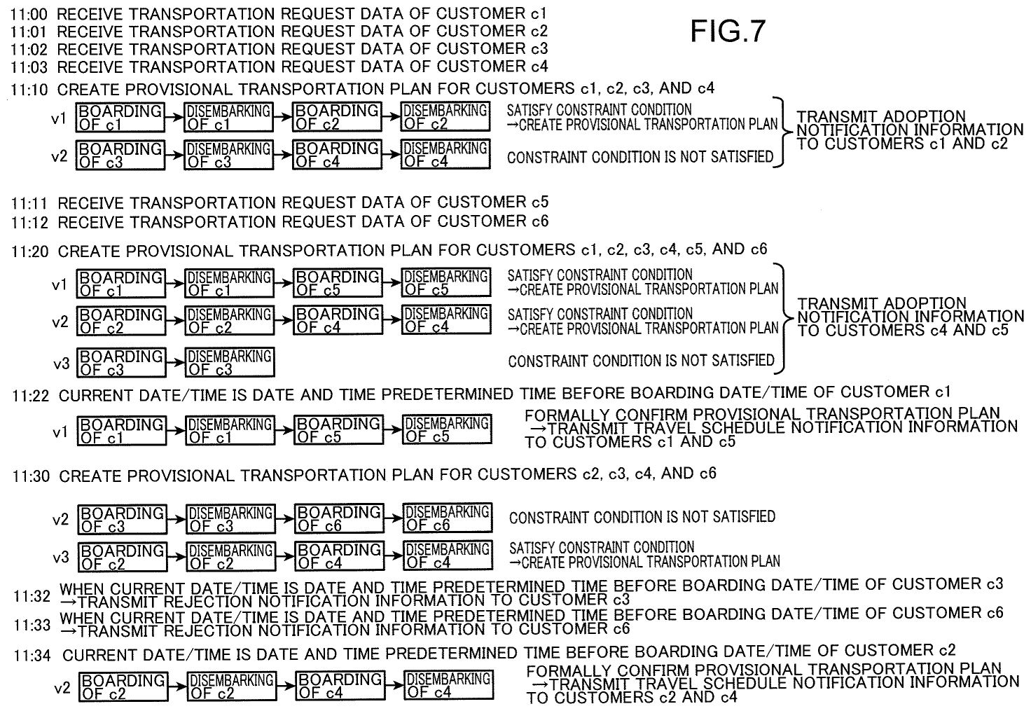

FIG. 7 is a schematic diagram for describing an operation from when the transportation plan creation server 1 receives the transportation request data to when the transportation plan creation server transmits the travel schedule notification information in the first embodiment.

In FIG. 7, in order to make the description easy to understand, a term from the boarding date/time to the date and time of transmitting the travel schedule notification information and a term from the boarding date/time to the date and time of transmitting the rejection notification information are set to significantly short terms.

The transportation request receiver 14 receives the transportation request data of a customer c1 at 11:00, receives the transportation request data of a customer c2 at 11:01, receives the transportation request data of a customer c3 at 11:02, and receives the transportation request data of a customer c4 at 11:03.

The transportation plan creator 15 creates a provisional transportation plan for the plurality of customers c1, c2, c3, and c4 at 11:10. Here, the transportation plan creator 15 creates the provisional transportation plan every ten minutes. As a result, the transportation plan creator 15 creates a first individual transportation plan in which the customers c1 and c2 are allocated to the first vehicle v1 and a second individual transportation plan in which the customers c3 and c4 are allocated to the second vehicle v2. At this time, the first individual transportation plan satisfies the predetermined constraint condition, but the second individual transportation plan does not satisfy the predetermined constraint condition. Therefore, the transportation plan creator 15 creates the provisional transportation plan in which the customers c1 and c2 are allocated to the first vehicle v1, but does not create the provisional transportation plan in which the customers c3 and c4 are allocated to the second vehicle v2.

Then, the transmitter 16 transmits the adoption notification information for notifying that transportation is possible to the customer terminals 2 of the customers c1 and c2 allocated to the provisional transportation plan.

Thereafter, the transportation request receiver 14 receives the transportation request data of a customer c5 at 11:11 and receives the transportation request data of a customer c6 at 11:12.

The transportation plan creator 15 creates a provisional transportation plan for the plurality of customers c1, c2, c3, c4, c5, and c6 at 11:20. As a result, the transportation plan creator 15 creates a first individual transportation plan in which the customers c1 and c5 are allocated to the first vehicle v1, a second individual transportation plan in which the customers c2 and c4 are allocated to the second vehicle v2, and a third individual transportation plan in which the customer c3 is allocated to the third vehicle v3. At this time, the first individual transportation plan and the second individual transportation plan satisfy the predetermined constraint condition, but the third individual transportation plan does not satisfy the predetermined constraint condition. Therefore, the transportation plan creator 15 creates the provisional transportation plan in which the customers c1 and c5 are allocated to the first vehicle v1 and the provisional transportation plan in which the customers c2 and c4 are allocated to the second vehicle v2, but does not create the provisional transportation plan in which the customer c3 is allocated to the third vehicle v3.

Then, the transmitter 16 transmits the adoption notification information for notifying that transportation is possible to the customer terminals 2 of the customers c4 and c5 newly allocated to the provisional transportation plan.

When a current date/time is 11:22 (first confirmation date/time), which is a predetermined time (first time) before the boarding date/time of the customer c1, the provisional transportation plan of the customers c1 and c5 is officially confirmed, and the transmitter 16 transmits the travel schedule notification information for notifying the customer terminal 2 of the customer c1 allocated to the provisional transportation plan of the travel schedule from the boarding to the disembarking of the customer c1, and transmits the travel schedule notification information for notifying the customer terminal 2 of the customer c5 allocated to the same provisional transportation plan of the travel schedule from the boarding to the disembarking of the customer 5.

Then, the transportation plan creator 15 creates a provisional transportation plan for the plurality of customers c2, c3, c4, and c6 at 11:30. As a result, the transportation plan creator 15 creates a first individual transportation plan in which the customers c3 and c6 are allocated to the second vehicle v2 and a second individual transportation plan in which the customers c2 and c4 are allocated to the third vehicle v3. At this time, the first individual transportation plan does not satisfy the predetermined constraint condition, but the second individual transportation plan satisfies the predetermined constraint condition. Therefore, the transportation plan creator 15 creates the provisional transportation plan in which the customers c2 and c4 are allocated to the third vehicle v3, but does not create the provisional transportation plan in which the customers c3 and c6 are allocated to the second vehicle v2.

When the current date/time reaches 11:32 (second confirmation date/time), which is a predetermined time (second time) before the boarding date/time of the customer c3, the transmitter 16 transmits rejection notification information for notifying that transportation is impossible, to the customer terminal 2 of the customer c3 not allocated to the provisional transportation plan.

When the current date/time reaches 11:33 (second confirmation date/time), which is a predetermined time (second time) before the boarding date/time of the customer c6, the transmitter 16 transmits rejection notification information for notifying that transportation is impossible, to the customer terminal 2 of the customer c6 not allocated to the provisional transportation plan.

When a current date/time is 11:34 (first confirmation date/time), which is a predetermined time (first time) before the boarding date/time of the customer c2, the provisional transportation plan of the customers c2 and c4 is officially confirmed, and the transmitter 16 transmits the travel schedule notification information for notifying the customer terminal 2 of the customer c2 allocated to the provisional transportation plan of the travel schedule from the boarding to the disembarking of the customer c2, and transmits the travel schedule notification information for notifying the customer terminal 2 of the customer c4 allocated to the same provisional transportation plan of the travel schedule from the boarding to the disembarking of the customer 4.

In a conventional demand bus service, all transportation requests received from customers are unconditionally adopted, and a transportation plan is created. Therefore, there has been a problem that it is difficult to secure the profitability of transportation in an area, a time period, or the like with a low density of occurrence of transportation requests.

On the other hand, in the vehicle dispatch management system according to the first embodiment, a transportation request received from a customer is not immediately adopted, and the transportation request is adopted only when allocated to the transportation plan capable of securing the profitability of transportation on the basis of a constraint condition set in advance. By collecting, over a certain period of time, transportation requests that allow ride sharing, more transportation plans capable of securing the profitability of transportation can be created.

A mechanism of aggregating the transportation requests over time to increase possibility of ride sharing and a mechanism of securing the profitability of transportation make it possible to create the transportation plan while securing the profitability of transportation with high probability even in an area, a time period, or the like with a low density of occurrence of transportation requests.

Next, the operation of the transportation plan creation server 1 in the first embodiment of the present disclosure will be described.

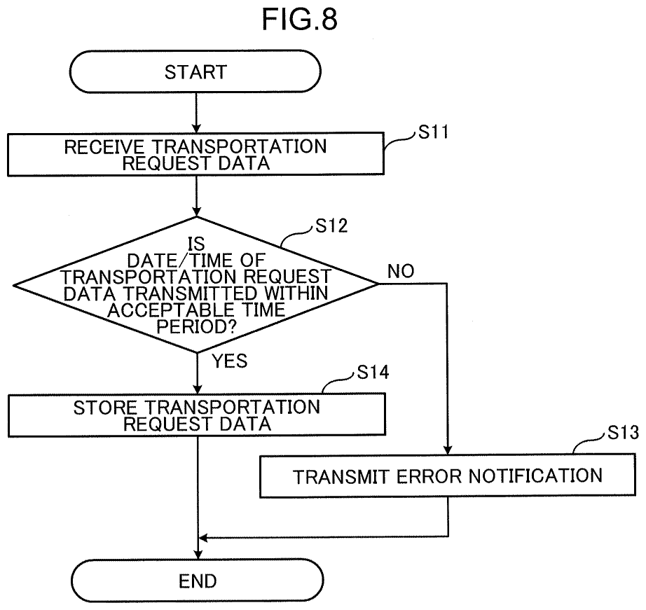

FIG. 8 is a flowchart for describing an operation of the transportation request receiver 14 of the transportation plan creation server 1 in the first embodiment of the present disclosure. Note that the operation illustrated in FIG. 8 is performed with reception of the transportation request data as a trigger.

First, in step S11, the transportation request receiver 14 receives the transportation request data transmitted by the customer terminal 2.

Next, in step S12, the transportation request receiver 14 determines whether the date and time when the transportation request data is transmitted is within an acceptable time period. As an example of the definition of the acceptable time period, 12 hours or more before the boarding date/time included in the transportation request data can be considered. Therefore, the transportation request receiver 14 receives the transportation request data if the date and time when the transportation request data is transmitted is within the acceptable time period, and does not receive the transportation request data if the date and time when the transportation request data is transmitted is outside the acceptable time period.

Here, when it is determined that the boarding date/time is not within a predetermined time period (NO in step S12), in step S13, the transportation request receiver 14 transmits an error notification indicating that the transportation request data cannot be received to the customer terminal 2 that has transmitted the transportation request data.

On the other hand, when it is determined that the boarding date/time is within the predetermined time period (YES in step S12), the transportation request receiver 14 stores the received transportation request data in the unallocated transportation request storage part 13 in step S14.

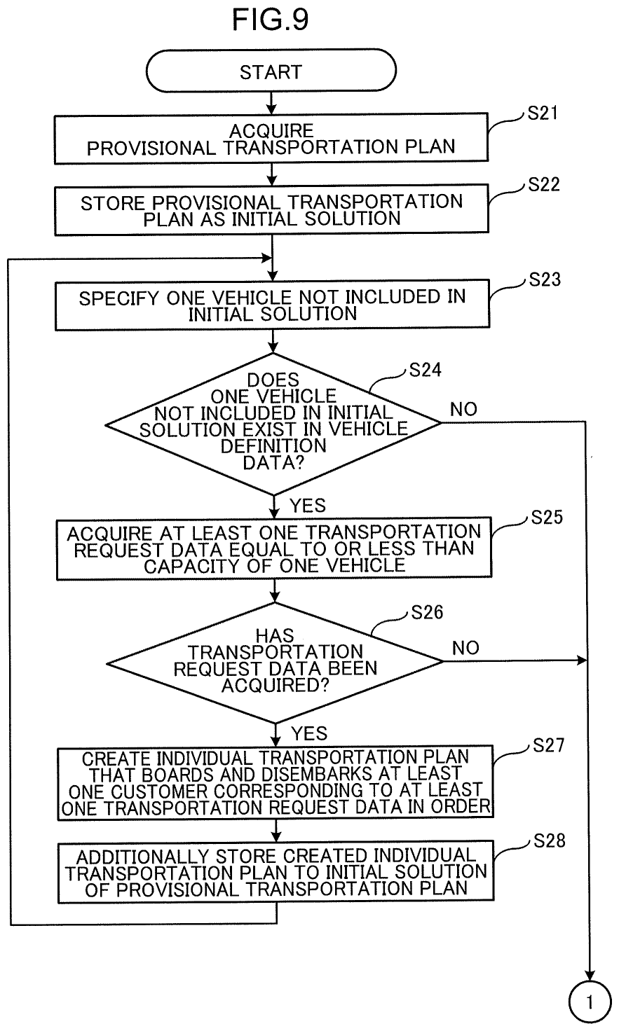

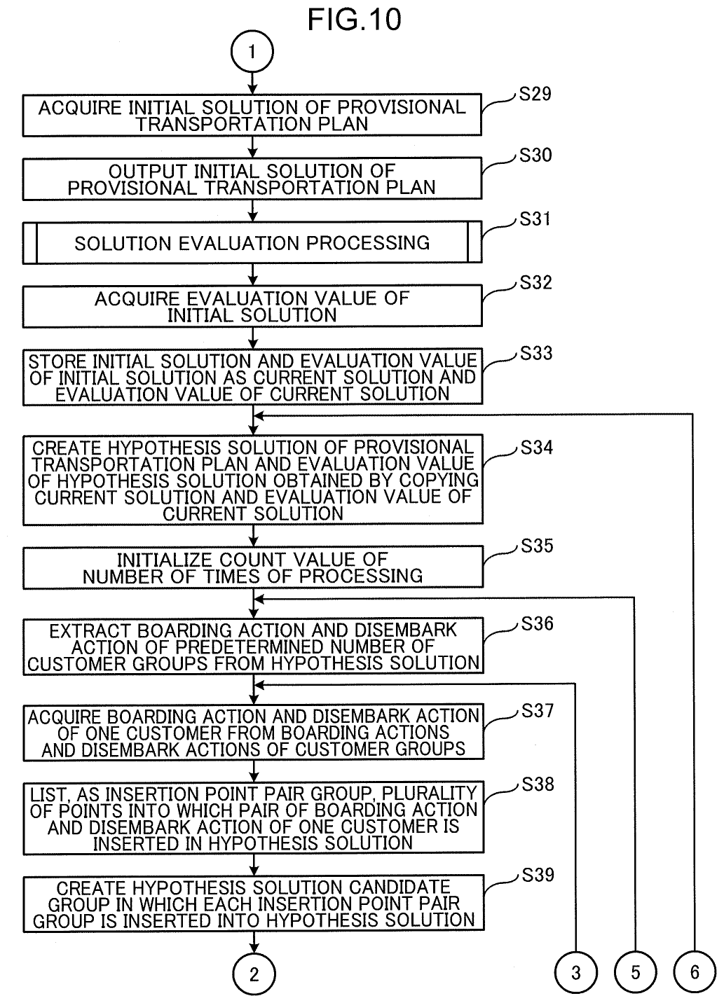

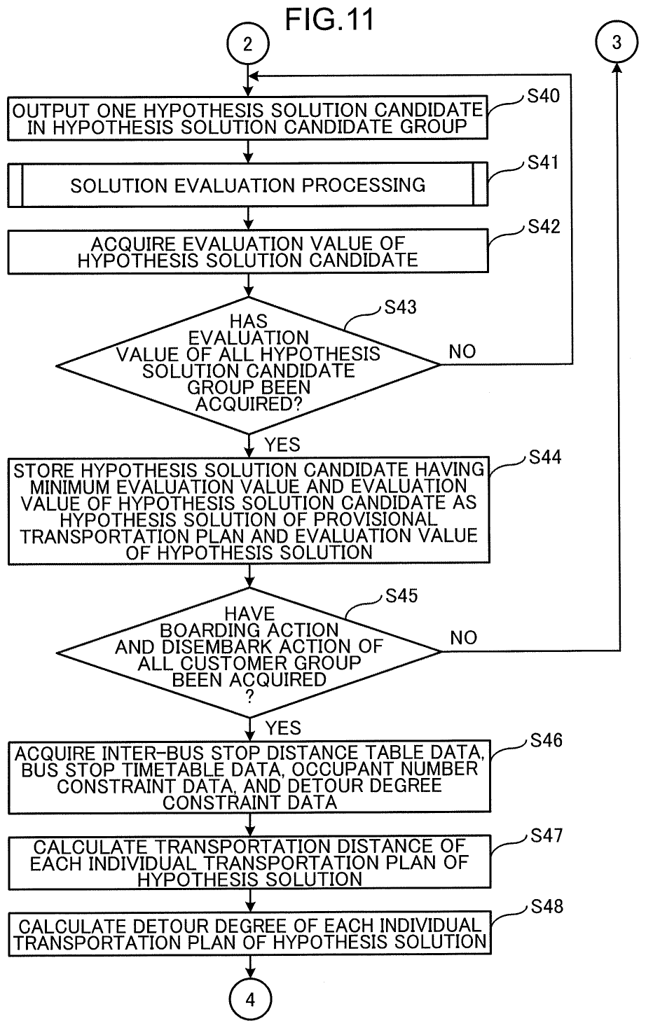

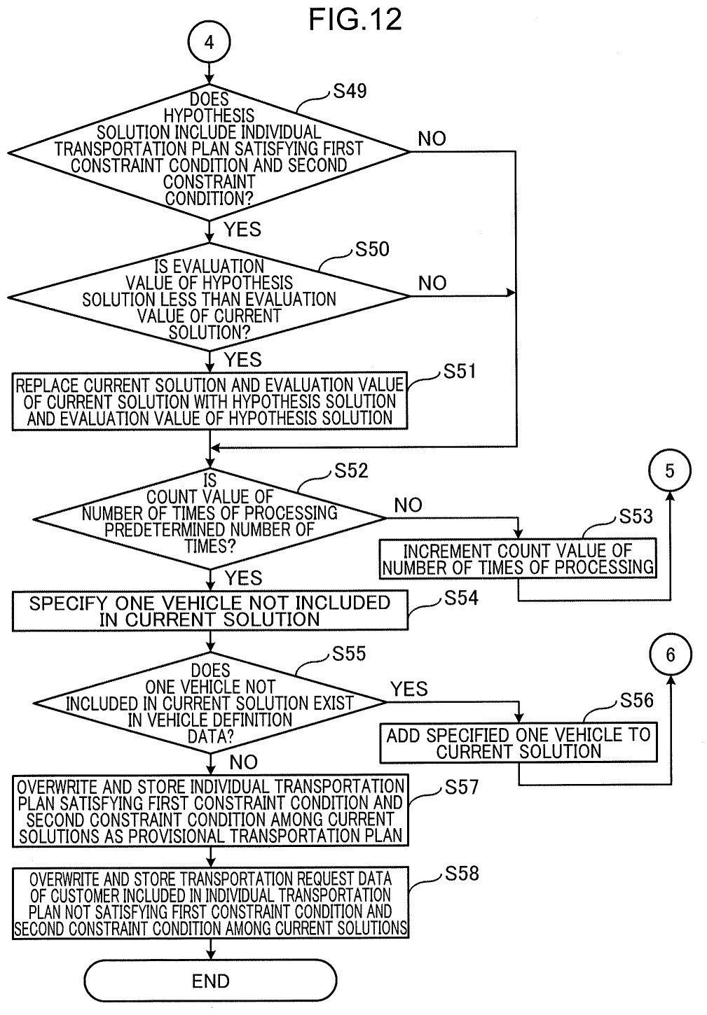

FIG. 9 is a first flowchart for describing the operation of the transportation plan creator 15 of the transportation plan creation server 1 according to the first embodiment of the present disclosure. FIG. 10 is a second flowchart for describing the operation of the transportation plan creator 15 of the transportation plan creation server 1 according to the first embodiment of the present disclosure. FIG. 11 is a third flowchart for describing the operation of the transportation plan creator 15 of the transportation plan creation server 1 according to the first embodiment of the present disclosure. FIG. 12 is a fourth flowchart for describing the operation of the transportation plan creator 15 of the transportation plan creation server 1 according to the first embodiment of the present disclosure. Note that the operations illustrated in FIGS. 9 to 12 are performed at predetermined time intervals such as every ten minutes, for example.

First, in step S21, the initial solution creator 151 acquires the provisional transportation plan stored in the provisional transportation plan storage part 12. The initial solution creator 151 reads the provisional transportation plan from the provisional transportation plan storage part 12. When the provisional transportation plan is not stored in the provisional transportation plan storage part 12, the initial solution creator 151 does not acquire the provisional transportation plan.

Next, in step S22, the initial solution creator 151 stores the provisional transportation plan acquired from the provisional transportation plan storage part 12 in the memory as an initial solution.

Next, in step S23, the initial solution creator 151 refers to the vehicle definition data stored in the setting data storage part 11 and specifies one vehicle that is not included in the initial solution of the provisional transportation plan.

Next, in step S24, the initial solution creator 151 determines whether the one vehicle not included in the initial solution of the provisional transportation plan exists in the vehicle definition data.

Here, when it is determined that one vehicle that is not included in the initial solution of the provisional transportation plan exists in the vehicle definition data (YES in step S24), in step S25, the initial solution creator 151 acquires at least one transportation request data equal to or less than the capacity of the specified one vehicle from the unallocated transportation request storage part 13.

Next, in step S26, the initial solution creator 151 determines whether the transportation request data has been acquired from the unallocated transportation request storage part 13. When the transportation request data does not exist in the unallocated transportation request storage part 13, the transportation request data is not acquired from the unallocated transportation request storage part 13.

Here, when it is determined that the transportation request data has been acquired (YES in step S26), in step S27, the initial solution creator 151 creates an individual transportation plan that boards and disembarks at least one customer corresponding to the acquired at least one transportation request data on one vehicle in order.

Next, in step S28, the initial solution creator 151 additionally stores the created individual transportation plan in the initial solution of the provisional transportation plan in the memory. The processing returns to step S23 after the processing of step S28.

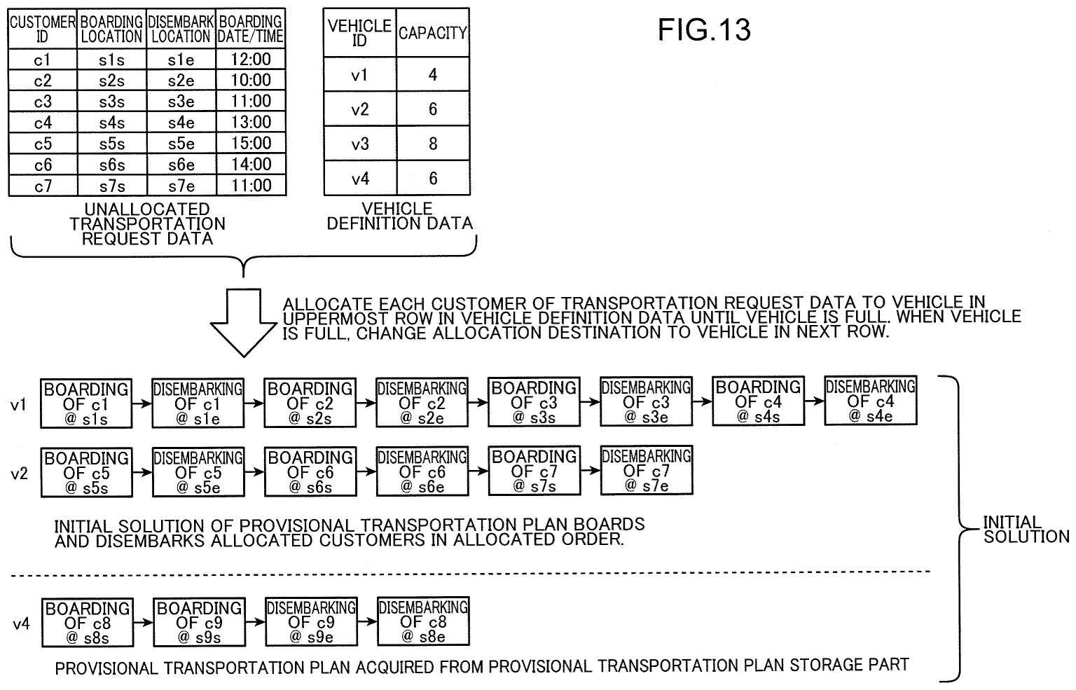

FIG. 13 is a schematic diagram for describing processing of creating the initial solution of the provisional transportation plan by the initial solution creator 151 in the first embodiment.

First, the initial solution creator 151 acquires the provisional transportation plan stored in the provisional transportation plan storage part 12, and stores the provisional transportation plan in the memory as an initial solution. In FIG. 13, the provisional transportation plan including the individual transportation plan in which a customer c8 and a customer c9 are allocated to a fourth vehicle v4 is acquired.

Next, the initial solution creator 151 specifies one vehicle that is not included in the initial solution from the vehicle definition data. Then, the initial solution creator 151 allocates each customer of the transportation request data stored in the unallocated transportation request storage part 13 to the specified one vehicle. At this time, the initial solution creator 151 allocates at least one customer corresponding to at least one transportation request data to the vehicle in the uppermost row in the vehicle definition data until the vehicle is full. When the vehicle is full, the initial solution creator 151 allocates the remaining customers to the vehicle in the next row in the vehicle definition data until the vehicle in the next row is full.

The initial solution of the provisional transportation plan boards and disembarks the allocated customers in the allocated order. In FIG. 13, an individual transportation plan in which the customer c1, the customer c2, the customer c3, and the customer c4 are allocated to the first vehicle v1, and an individual transportation plan in which the customer c5, the customer c6, and a customer c7 are allocated to the second vehicle v2 are created.

The individual transportation plan of the first vehicle v1 and the individual transportation plan of the second vehicle v2 are added to the initial solution of the provisional transportation plan. As a result, an initial solution of the provisional transportation plan including the individual transportation plan of the first vehicle v1, the second vehicle v2, and the fourth vehicle v4 is created.

Referring to FIG. 9 again, when it is determined that one vehicle that is not included in the initial solution of the provisional transportation plan does not exist in the vehicle definition data (NO in step S24), or when it is determined that the transportation request data is not acquired (NO in step S26), in step S29, the improved solution creator 152 acquires the initial solution of the provisional transportation plan created by the initial solution creator 151 from the memory.

Next, in step S30, the improved solution creator 152 outputs the acquired initial solution of the provisional transportation plan to the evaluator 153.

Next, in step S31, the evaluator 153 executes solution evaluation processing of calculating an evaluation value of the initial solution of the provisional transportation plan created by the initial solution creator 151. Note that the solution evaluation processing will be described later.

Next, in step S32, the improved solution creator 152 acquires the evaluation value of the initial solution of the provisional transportation plan from the evaluator 153.

Next, in step S33, the improved solution creator 152 stores the initial solution of the provisional transportation plan created by the initial solution creator 151 and the evaluation value of the initial solution in the memory as the current solution of the provisional transportation plan and the evaluation value of the current solution.

Next, in step S34, the improved solution creator 152 creates a hypothesis solution of the provisional transportation plan and an evaluation value of the hypothesis solution obtained by copying the current solution of the provisional transportation plan and the evaluation value of the current solution stored in the memory.

Next, in step S35, the improved solution creator 152 initializes a count value of the number of times of processing. That is, the improved solution creator 152 sets the count value of the number of times of processing to 0.

Next, in step S36, the improved solution creator 152 extracts boarding actions and disembark actions of a predetermined number of customer groups from the hypothesis solution of the provisional transportation plan. The improved solution creator 152 randomly determines the boarding actions and the disembark actions of the customer groups to be extracted.

Next, in step S37, the improved solution creator 152 acquires the boarding action and the disembark action of one customer from the extracted boarding actions and disembark actions of the customer groups.

Next, in step S38, the improved solution creator 152 lists, as an insertion point pair group, a plurality of points into which a pair of boarding action and disembark action of one customer is inserted in the hypothesis solution of the provisional transportation plan. The insertion point pair needs to satisfy a condition that the insertion point of the boarding action belongs to the same vehicle as the disembark action and is ahead of the insertion point of the disembark action in the transportation plan, and a condition that the capacity of the vehicle is not exceeded as a result of inserting the boarding action and the disembark action.

Next, in step S39, the improved solution creator 152 creates a hypothesis solution candidate group in which each insertion point pair group is inserted into the hypothesis solution of the provisional transportation plan.

Next, in step S40, the improved solution creator 152 outputs one hypothesis solution candidate in the hypothesis solution candidate group of the provisional transportation plan to the evaluator 153.

Next, in step S41, the evaluator 153 executes solution evaluation processing of calculating an evaluation value of the hypothesis solution candidate of the provisional transportation plan created by the improved solution creator 152. Note that the solution evaluation processing will be described later.

Next, in step S42, the improved solution creator 152 acquires the evaluation value of the hypothesis solution candidate of the provisional transportation plan from the evaluator 153.

Next, in step S43, the improved solution creator 152 determines whether the evaluation values of all the hypothesis solution candidate groups of the provisional transportation plan have been acquired. Here, when it is determined that the evaluation values of all the hypothesis solution candidate groups of the provisional transportation plan have not been acquired (NO in step S43), the processing returns to step S40. Then, the improved solution creator 152 outputs, to the evaluator 153, another one hypothesis solution candidate of which the evaluation value has not been acquired yet among the hypothesis solution candidate group of the provisional transportation plan.

On the other hand, when it is determined that the evaluation values of all the hypothesis solution candidate groups of the provisional transportation plan have been acquired (YES in step S43), in step S44, the improved solution creator 152 stores the hypothesis solution candidate having a minimum evaluation value and the evaluation value of the hypothesis solution candidate in the memory as the hypothesis solution of the provisional transportation plan and the evaluation value of the hypothesis solution.

Next, in step S45, the improved solution creator 152 determines whether the boarding action and the disembark action of all the extracted customer groups have been acquired. Here, when it is determined that the boarding action and the disembark action of all the customer groups have not been acquired (NO in step S45), the processing returns to step S37. Then, the improved solution creator 152 acquires the boarding action and the disembark action of another one customer that have not been acquired yet from the extracted boarding actions and disembark actions of the customer groups.

On the other hand, when it is determined that the boarding action and the disembark action of all the customer groups have been acquired (YES in step S45), in step S46, the improved solution creator 152 acquires the inter-bus stop distance table data, the bus stop timetable data, the occupant number constraint data, and the detour degree constraint data from the setting data storage part 11.

Next, in step S47, the improved solution creator 152 calculates the transportation distance of each individual transportation plan of the hypothesis solution of the provisional transportation plan on the basis of the acquired inter-bus stop distance table data. The transportation distance is a distance from a boarding location of a customer who boards the vehicle first to a disembark location of a customer who disembarks the vehicle finally. The transportation distance of each individual transportation plan can be calculated by summing the distances between bus stops.

When the stop place of the vehicle is not determined in advance and the boarding location and the disembark location are arbitrary places, the improved solution creator 152 may calculate a transportation route of each individual transportation plan and the transportation distance between the stop places on the basis of map information.

Next, in step S48, the improved solution creator 152 calculates the detour degree of each individual transportation plan of the hypothesis solution of the provisional transportation plan on the basis of the acquired bus stop timetable data. The detour degree is a value obtained by dividing the overall transportation time from when a plurality of customers allocated to one vehicle among a plurality of vehicles included in the hypothesis solution of the provisional transportation plan is first boarded to when the plurality of customers is finally disembarked by the total time of the individual transportation time for individually transporting the plurality of customers allocated to the one vehicle. The overall transportation time and the individual transportation time can be calculated by summing the time between bus stops.

When the stop place of the vehicle is not determined in advance and the boarding location and the disembark location are arbitrary places, the improved solution creator 152 may calculate a transportation route of each individual transportation plan and the transportation time between the stop places on the basis of map information.

Next, in step S49, the improved solution creator 152 determines whether the hypothesis solution of the provisional transportation plan includes the individual transportation plan satisfying the first constraint condition and the second constraint condition on the basis of the acquired occupant number constraint data and the detour degree constraint data.

The improved solution creator 152 acquires the lower limit value of the number of occupants corresponding to the transportation distance of each calculated individual transportation plan from the occupant number constraint data, and determines that the individual transportation plan of the hypothesis solution satisfies the first constraint condition when the number of occupants of each individual transportation plan of the hypothesis solution is equal to or larger than the acquired lower limit value.

The improved solution creator 152 acquires the threshold of the detour degree from the detour degree constraint data, and determines that the individual transportation plan of the hypothesis solution satisfies the second constraint condition when the calculated detour degree of each individual transportation plan is equal to or less than the acquired threshold.

Here, when it is determined that the hypothesis solution of the provisional transportation plan does not include the individual transportation plan satisfying the first constraint condition and the second constraint condition (NO in step S49), the processing proceeds to step S52.

On the other hand, when it is determined that the hypothesis solution of the provisional transportation plan includes the individual transportation plan satisfying the first constraint condition and the second constraint condition (YES in step S49), in step S50, the improved solution creator 152 determines whether the evaluation value of the hypothesis solution is less than the evaluation value of the current solution. Here, when it is determined that the evaluation value of the hypothesis solution is equal to or more than the evaluation value of the current solution (NO in step S50), the processing proceeds to step S52.

On the other hand, when it is determined that the evaluation value of the hypothesis solution is less than the evaluation value of the current solution (YES in step S50), in step S51, the improved solution creator 152 replaces the current solution of the provisional transportation plan and the evaluation value of the current solution stored in the memory with the hypothesis solution of the provisional transportation plan and the evaluation value of the hypothesis solution.

Next, in step S52, the improved solution creator 152 determines whether the count value of the number of times of processing is a predetermined number of times. Here, when it is determined that the count value of the number of times of processing is not the predetermined number of times (NO in step S52), the improved solution creator 152 increments the count value of the number of times of processing in step S53. After the processing of step S53 is performed, the processing returns to step S36.

On the other hand, when it is determined that the count value of the number of times of processing is the predetermined number of times (YES in step S52), in step S54, the improved solution creator 152 refers to the vehicle definition data stored in the setting data storage part 11 and specifies one vehicle that is not included in the current solution of the provisional transportation plan.

Next, in step S55, the improved solution creator 152 determines whether the one vehicle not included in the current solution of the provisional transportation plan exists in the vehicle definition data.

Here, when it is determined that there is one vehicle not included in the current solution of the provisional transportation plan in the vehicle definition data (YES in step S55), in step S56, the improved solution creator 152 adds the specified one vehicle to the current solution of the provisional transportation plan. As a result, one vehicle to which no customer is allocated is added to the current solution of the provisional transportation plan, and a more optimal solution can be created. Then, after the processing of step S56 is performed, the processing returns to step S34.

On the other hand, when it is determined that one vehicle not included in the current solution of the provisional transportation plan does not exist in the vehicle definition data (NO in step S55), in step S57, the improved solution creator 152 overwrites and stores the individual transportation plan satisfying the first constraint condition and the second constraint condition among the current solutions of the provisional transportation plan in the provisional transportation plan storage part 12 as the provisional transportation plan.

Next, in step S58, the improved solution creator 152 overwrites and stores the transportation request data of the customer included in the individual transportation plan that does not satisfy the first constraint condition and the second constraint condition among the current solutions of the provisional transportation plan in the unallocated transportation request storage part 13.

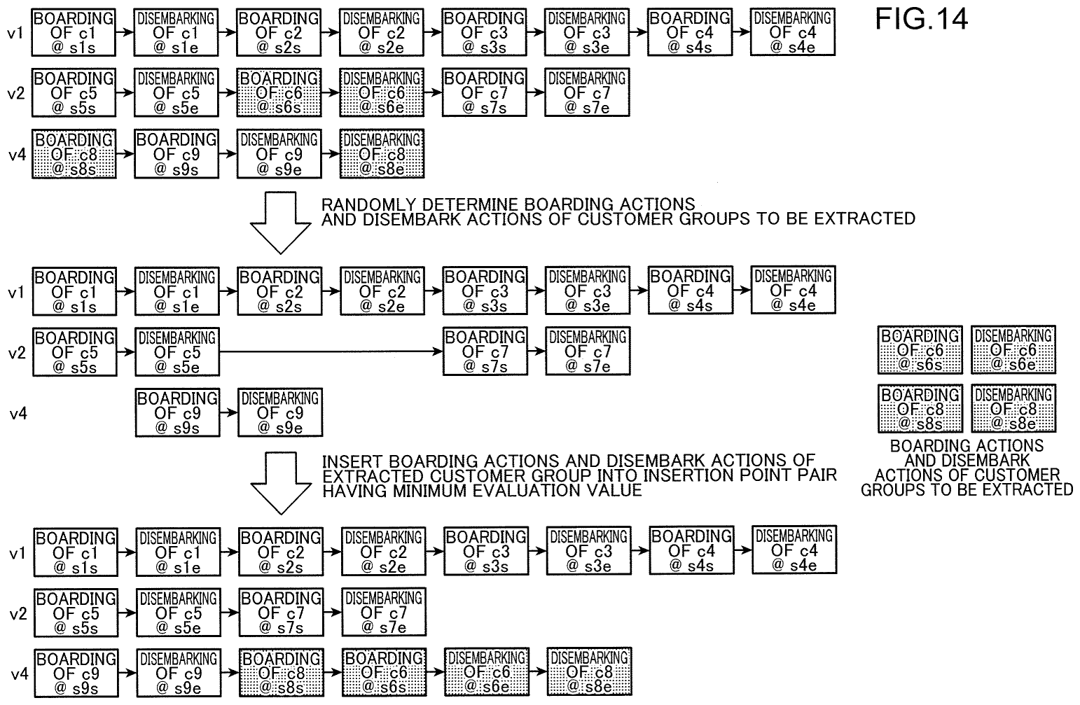

FIG. 14 is a schematic diagram for describing processing of creating the hypothesis solution of the provisional transportation plan by the improved solution creator 152 in the first embodiment.

The improved solution creator 152 randomly determines the boarding actions and the disembark actions of a predetermined number of customer groups extracted from the hypothesis solution of the provisional transportation plan, and extracts the boarding actions and the disembark actions of the customer group from the hypothesis solution of the provisional transportation plan.

In FIG. 14, the boarding action and the disembark action of the customer c6 are extracted from the individual transportation plan of the second vehicle v2, and the boarding action and the disembark action of the customer c8 are extracted from the individual transportation plan of the fourth vehicle v4.

Finally, the improved solution creator 152 inserts the boarding actions and the disembark actions of the extracted customer group into the insertion point pair having the minimum evaluation value. In FIG. 14, the boarding action and the disembark action of the customer c6 and the customer c8 are inserted into the individual transportation plan of the fourth vehicle v4. As a result, the improved solution creator 152 creates a hypothesis solution of the provisional transportation plan having the minimum evaluation value.

Next, details of the solution evaluation processing in step S31 in FIG. 10 and step S41 in FIG. 11 will be described.

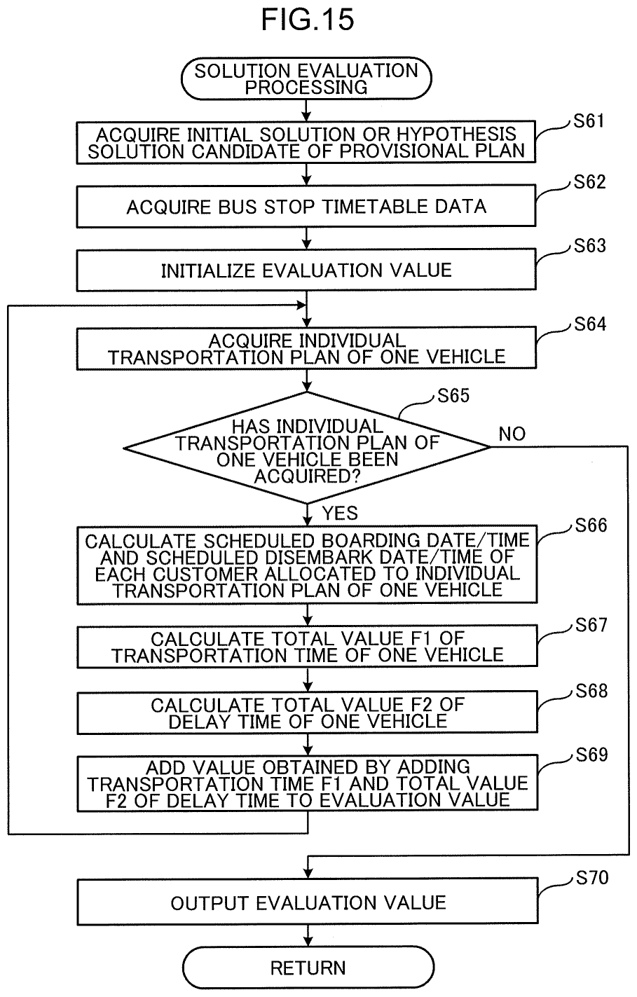

FIG. 15 is a flowchart for describing the solution evaluation processing of the

transportation plan creation server 1 in the first embodiment.

First, in step S61, the evaluator 153 acquires the initial solution of the provisional transportation plan created by the initial solution creator 151 or the hypothesis solution candidate of the provisional transportation plan created by the improved solution creator 152. In the solution evaluation processing of step S31 in FIG. 10, the evaluator 153 acquires an initial solution of the provisional transportation plan created by the initial solution creator 151. In the solution evaluation processing of step S41 in FIG. 11, the evaluator 153 acquires a hypothesis solution candidate of the provisional transportation plan created by the improved solution creator 152.

Next, in step S62, the evaluator 153 acquires the bus stop timetable data from the setting data storage part 11.

Next, in step S63, the evaluator 153 initializes the evaluation value. That is, the evaluator 153 sets the evaluation value to 0.

Next, in step S64, the evaluator 153 acquires the individual transportation plan of one vehicle from the initial solution or the hypothesis solution candidate of the provisional transportation plan.

Next, in step S65, the evaluator 153 determines whether the individual transportation plan of one vehicle has been acquired from the initial solution or the hypothesis solution candidate of the provisional transportation plan.

Here, when it is determined that the individual transportation plan of one vehicle has been acquired (YES in step S65), in step S66, the evaluator 153 calculates the scheduled boarding date/time and the scheduled disembark date/time of each customer allocated to the individual transportation plan of the one vehicle. At this time, the evaluator 153 calculates the desired boarding date/time included in the transportation request data of a top customer of the individual transportation plan as the scheduled boarding date/time of the top customer. Then, the evaluator 153 calculates the scheduled boarding date/time and the scheduled disembark date/time of the second and subsequent customers by adding the time between bus stops shown in the bus stop timetable data. However, in a case where the scheduled boarding date/time of the customer is earlier than the desired boarding date/time, the vehicle stands by at the bus stop until the desired boarding date/time. Therefore, when the scheduled boarding date/time of the customer is earlier than the desired boarding date/time, the evaluator 153 changes the scheduled boarding date/time to the desired boarding date/time of the customer, and calculates the scheduled boarding date/time and the scheduled disembark date/time of the following customer.

When the stop place of the vehicle is not determined in advance and the boarding location and the disembark location are arbitrary places, the evaluator 153 may calculate a transportation route of each individual transportation plan and the transportation time between the stop places on the basis of map information.

Next, in step S67, the evaluator 153 calculates the total value F1 of the transportation time of one vehicle. At this time, the evaluator 153 calculates the total value F1 of the transportation time by subtracting the scheduled boarding date/time of the customer who boards the one vehicle first from the scheduled disembark date/time of the customer who disembarks the one vehicle last.

Next, in step S68, when the scheduled boarding date/time of each customer allocated to the individual transportation plan of one vehicle is delayed from the desired boarding date/time of the transportation request data, the evaluator 153 calculates a difference between the scheduled boarding date/time and the desired boarding date/time as a delay time, and calculates a total value F2 of delay time of the one vehicle.

Next, in step S69, the evaluator 153 adds the total value F2 of the delay time multiplied by the coefficient α to the total value F1 of the transportation time, and adds the addition value to the evaluation value. The processing returns to step S64 after the processing of step S69.

Then, the processing of steps S64 to S69 is performed until the individual transportation plans of all the vehicles are acquired from the initial solution or the hypothesis solution candidate of the provisional transportation plan.

On the other hand, when it is determined that the individual transportation plan of one vehicle is not acquired from the initial solution or the hypothesis solution candidate of the provisional transportation plan (NO in step S65), the evaluator 153 outputs the calculated evaluation value to the improved solution creator 152 in step S70. In the solution evaluation processing of step S31 in FIG. 10, the evaluator 153 outputs the calculated evaluation value of the initial solution to the improved solution creator 152. In the solution evaluation processing in step S41 in FIG. 11, the evaluator 153 outputs the calculated evaluation value of the hypothesis solution candidate to the improved solution creator 152.

In the first embodiment, the evaluator 153 calculates the total value of the transportation time of one vehicle, but the present disclosure is not limited to this calculation, and the evaluator 153 may calculate the total value of the transportation distance of the one vehicle. In this case, the evaluator 153 may calculate the total value of the transportation distance by summing the distances between bus stops from the boarding location of the customer who first boards the one vehicle to the disembark location of the customer who disembarks the one vehicle last by using the inter-bus stop distance table data.

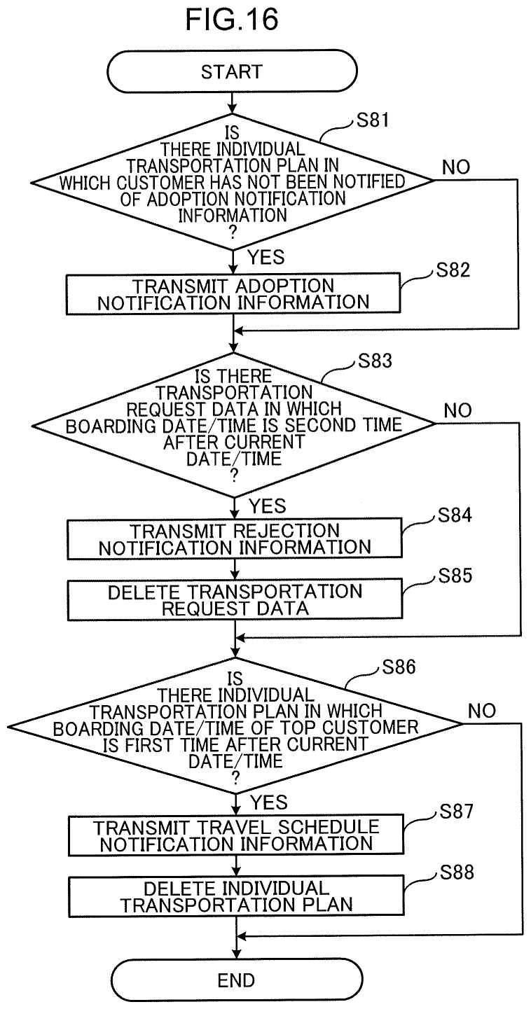

FIG. 16 is a flowchart for describing an operation of the transmitter 16 of the transportation plan creation server 1 in the first embodiment of the present disclosure. Note that the operation illustrated in FIG. 16 is performed at predetermined time intervals such as every one minute, for example.

First, in step S81, the transmitter 16 determines whether there is an individual transportation plan in which the customer is not notified of the adoption notification information among the provisional transportation plans stored in the provisional transportation plan storage part 12. Here, when it is determined that there is no individual transportation plan in which the customer is not notified of the adoption notification information (NO in step S81), the processing proceeds to step S83.

On the other hand, when it is determined that there is an individual transportation plan in which the customer is not notified of the adoption notification information (YES in step S81), in step S82, the transmitter 16 transmits the adoption notification information to the customer terminal 2 of each of the plurality of customers allocated to the unnotified individual transportation plan. The transmitter 16 may add a notification completion flag to the individual transportation plan in which the adoption notification information has been transmitted. This makes it easy to determine whether there is an individual transportation plan in which the customer has not been notified of the adoption notification information.

Next, in step S83, the transmitter 16 determines whether there is transportation request data in which the boarding date/time is the second time after the current date/time among the transportation request data stored in the unallocated transportation request storage part 13. Here, when it is determined that there is no transportation request data in which the boarding date/time is the second time after the current date/time (NO in step S83), the processing proceeds to step S86.

On the other hand, when it is determined that there is transportation request data in which the boarding date/time is the second time after the current date/time (YES in step S83), in step S84, the transmitter 16 transmits the rejection notification information to the customer terminal 2 of the customer of the transportation request data in which the boarding date/time is the second time after the current date/time.

Next, in step S85, the transmitter 16 deletes the transportation request data to the customer to which the rejection notification information has been transmitted from the unallocated transportation request storage part 13.

Next, in step S86, the transmitter 16 determines whether there is an individual transportation plan in which the boarding date/time of the top customer is the first time after the current date/time among the provisional transportation plans stored in the provisional transportation plan storage part 12.

Here, when it is determined that there is no individual transportation plan in which the boarding date/time of the top customer is the first time after the current date/time (NO in step S86), the processing ends.

On the other hand, when it is determined that there is an individual transportation plan in which the boarding date/time of the top customer is the first time after the current date/time (YES in step S86), in step S87, the transmitter 16 transmits the travel schedule notification information to the customer terminal 2 of each of the plurality of customers allocated to the individual transportation plan in which the boarding date/time of the top customer is the first time after the current date/time.

Next, in step S88, the transmitter 16 deletes the individual transportation plan including the plurality of customers to which the travel schedule notification information is transmitted from the provisional transportation plan of the provisional transportation plan storage part 12.

Note that the individual transportation plan deleted from the provisional transportation plan is an individual transportation plan in which the travel schedule is officially confirmed. An actual operation system having a function of instructing a bus operation has a function of storing a confirmed individual transportation plan and instructing the bus (driver) to operate.

In this manner, the provisional transportation plan in which the plurality of customers is allocated to the plurality of vehicles such that the predetermined constraint conditions is satisfied is periodically created on the basis of the plurality of transportation requests until the first confirmation date/time for confirming the provisional transportation plan. Therefore, even in an area with little transportation demand, it is possible to acquire transportation requests from more customers and allocate more customers to a plurality of vehicles, and it is thus possible to create a transportation plan capable of securing the profitability of transportation.

Subsequently, various screens displayed on the customer terminal 2 will be described.

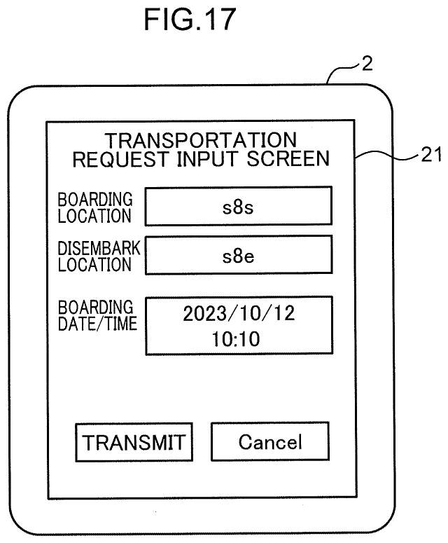

FIG. 17 is a diagram illustrating an example of a transportation request input screen displayed on the customer terminal 2 in the first embodiment.

Each of the plurality of customer terminals 2 includes a display part 21 configured by a liquid crystal display device or a touch panel. As illustrated in FIG. 17, the display part 21 displays the transportation request input screen for receiving input of the boarding location, the disembark location, and the boarding date/time by a customer. The customer inputs the boarding location, the disembark location, and the boarding date/time on the displayed transportation request input screen. In the first embodiment, since the operation route and the stop place of the vehicle are determined in advance, the customer selects the boarding location and the disembark location from among a plurality of predetermined stop places.

The transportation request input screen includes a transmission button and a cancel button. When the transmission button is clicked or touched, the transportation request data including the customer ID, the boarding location, the disembark location, and the boarding date/time is transmitted to the transportation plan creation server 1. When the cancel button is clicked or touched, the input boarding location, disembark location, and boarding date/time are canceled.

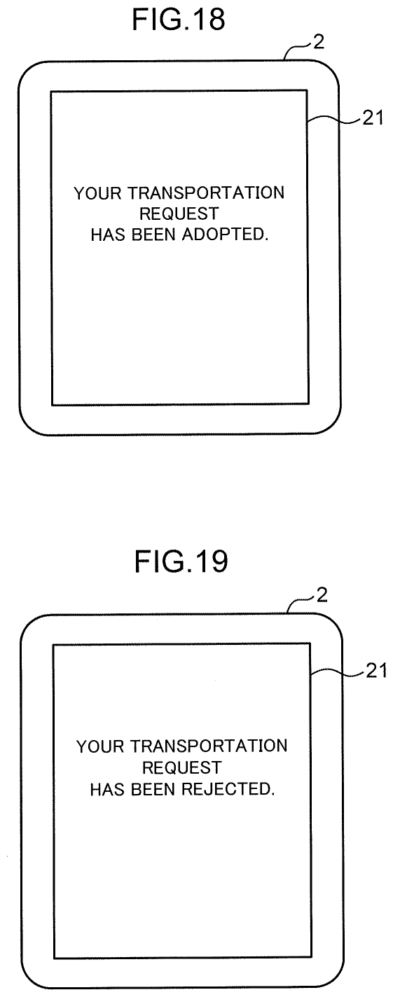

FIG. 18 is a diagram illustrating an example of an adoption notification screen displayed on the customer terminal 2 in the first embodiment.

The customer terminal 2 receives the adoption notification information transmitted by the transportation plan creation server 1. When the adoption notification information is received, the display part 21 of the customer terminal 2 displays the adoption notification screen for notifying that the transportation request of the customer is adopted. The adoption notification screen illustrated in FIG. 18 includes a sentence indicating that the transportation request from the customer has been adopted.

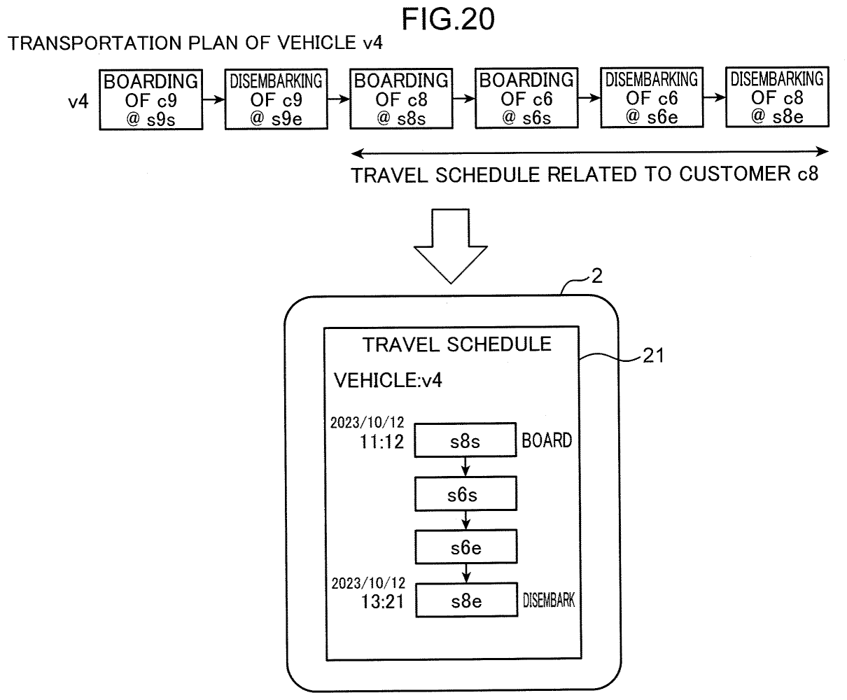

FIG. 19 is a diagram illustrating an example of a rejection notification screen displayed on the customer terminal 2 in the first embodiment.

The customer terminal 2 receives the rejection notification information transmitted by the transportation plan creation server 1. When the rejection notification information is received, the display part 21 of the customer terminal 2 displays the rejection notification screen for notifying that the transportation request of the customer has not been adopted. The rejection notification screen illustrated in FIG. 19 includes a sentence indicating that the transportation request from the customer has not been adopted.

FIG. 20 is a diagram illustrating an example of a travel schedule notification screen displayed on the customer terminal 2 in the first embodiment.

The customer terminal 2 receives the travel schedule notification information transmitted by the transportation plan creation server 1. When the travel schedule notification information is received, the display part 21 of the customer terminal 2 displays the travel schedule notification screen for notifying the travel schedule of the customer.

As illustrated in FIG. 20, when the provisional transportation plan in which the customers c6, c8, and c9 are allocated to the fourth vehicle v4 is confirmed, the transmitter 16 of the transportation plan creation server 1 transmits the travel schedule notification information to each of the customers c6, c8, and c9. The travel schedule notification screen illustrated in FIG. 20 shows the travel schedule of the customer c8. The travel schedule notification screen includes the vehicle ID, the boarding location, the scheduled boarding date/time, the disembark location, the scheduled disembark date/time, and a transit point of the vehicle that the customer c8 boards. The transit point indicates a bus stop at which the vehicle stops between the boarding location and the disembark location of the customer c8.

In FIG. 20, the customer c8 boards the fourth vehicle v4 at a bus stop s8s at 11:12, passes through a bus stop s6s and a bus stop s6e, and disembarks the fourth vehicle v4 at a bus stop s8e at 11:21.

Note that the scheduled boarding date/time included in the travel schedule notification information may be later than the boarding date/time included in the transportation request data.

The operation of the customer terminal 2 is as follows. First, the customer terminal 2 transmits the transportation request data to the transportation plan creation server 1. Next, the customer terminal 2 stands by until receiving the adoption notification information or the rejection notification information. Then, the customer terminal 2 receives the adoption notification information or the rejection notification information. Next, when receiving the adoption notification information, the customer terminal 2 stands by until receiving the travel schedule notification information. Then, the customer terminal 2 receives the travel schedule notification information.

The transmitter 16 may output the first standby notification information for notifying that a standby time until it is determined whether transportation is possible occurs between the acquisition of the transportation request data and the output of the adoption notification information or the rejection notification information. That is, the transmitter 16 may transmit the first standby notification information to the customer terminal 2. The customer terminal 2 may receive the first standby notification information in a first standby time from the transmission of the transportation request data to the reception of the adoption notification information or the rejection notification information, and display a first message screen for notifying the customer of the occurrence of the standby time.

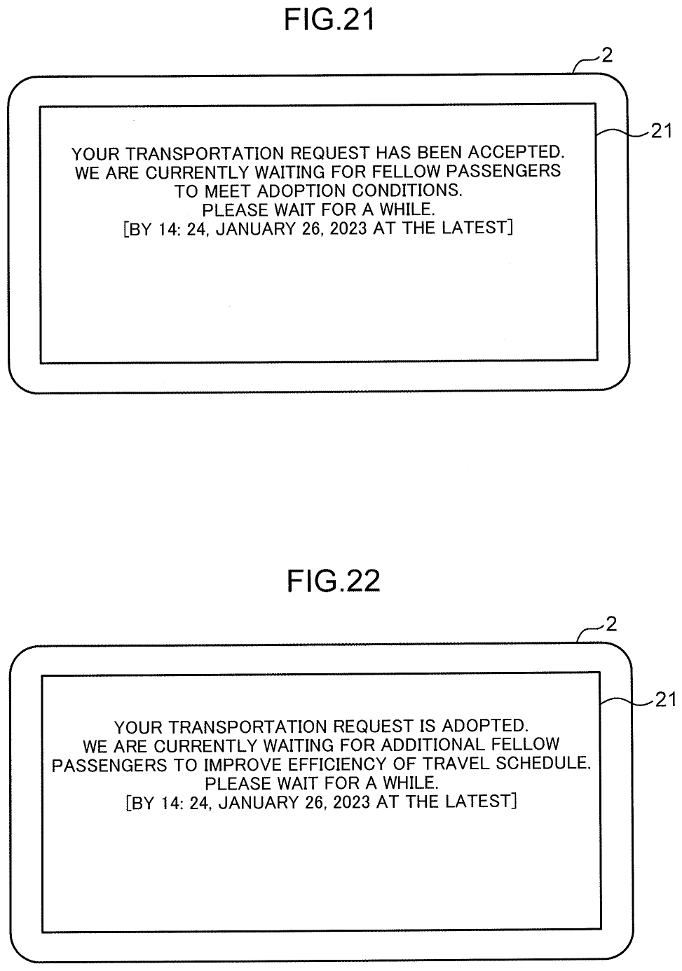

FIG. 21 is a diagram illustrating an example of the first message screen displayed on the customer terminal 2 in the first embodiment.

After the transportation request data is transmitted, the display part 21 of the customer terminal 2 displays the first message screen for notifying the customer of the occurrence of the standby time. The first message screen illustrated in FIG. 21 includes a sentence for notifying the customer of the occurrence of the standby time. The first message screen includes an end date/time of the standby time. The end date/time of the standby time is a date and time obtained by subtracting the second time from the boarding date/time included in the transportation request data.

The transmitter 16 may output the second standby notification information for notifying that the standby time until the travel schedule is determined occurs during a period from the output of the adoption notification information to the output of the travel schedule notification information. That is, the transmitter 16 may transmit the second standby notification information to the customer terminal 2. The customer terminal 2 may receive the second standby notification information in a second standby time from the reception of the adoption notification information to the reception of the travel schedule notification information, and display a second message screen for notifying the customer of the occurrence of the standby time.

FIG. 22 is a diagram illustrating an example of the second message screen displayed on the customer terminal 2 in the first embodiment.

After the adoption notification information is received, the display part 21 of the customer terminal 2 displays the first message screen for notifying the customer of the occurrence of the standby time. The second message screen illustrated in FIG. 22 includes a sentence for notifying the customer of the occurrence of the standby time. The second message screen includes an end date/time of the standby time. The end date/time of the standby time is a date and time obtained by subtracting the first time from the boarding date/time of the top customer of the individual transportation plan to which the customer is allocated.

### Second Embodiment

In a transportation area covered by a transportation operating company, there is a possibility that a subarea in which the profitability of transportation can be actually secured and a subarea in which the profitability of transportation cannot be secured are mixed. Even in the same subarea, there is a possibility that a time period in which the profitability of transportation can be secured and a time period in which the profitability of transportation cannot be secured are mixed. In this case, a transportation plan creation method according to the first embodiment is sufficient to be applied only to the subarea in which the profitability of transportation cannot be secured.

Therefore, in a second embodiment, a transportation plan creation server using both the conventional transportation plan creation method and the transportation plan creation method according to the first embodiment will be described.

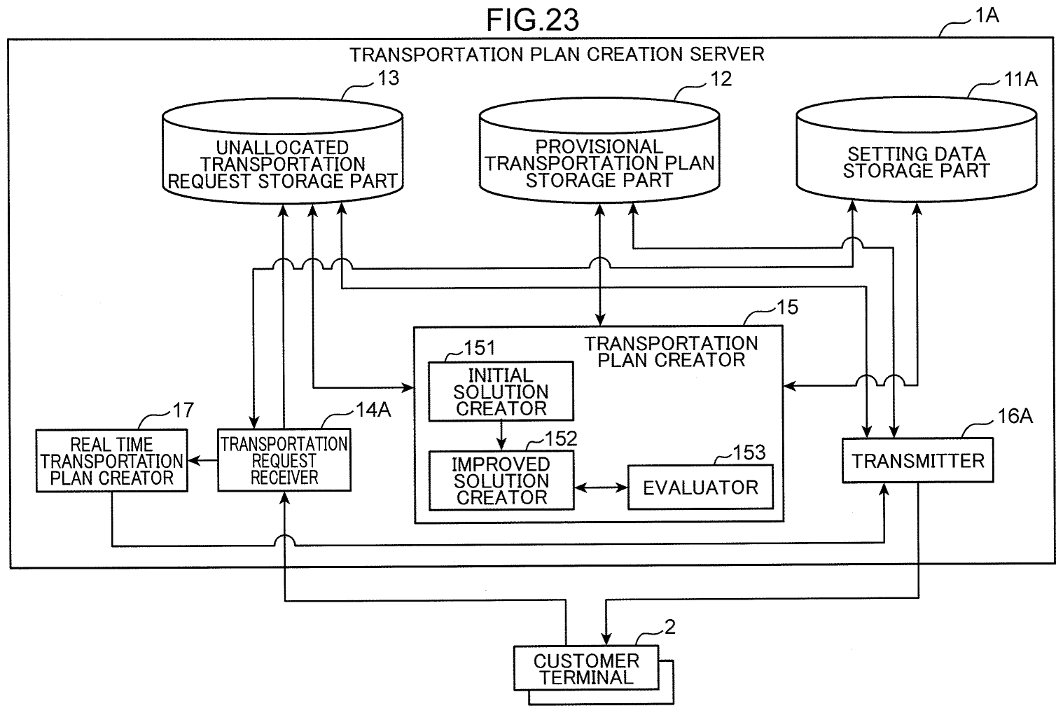

FIG. 23 is a diagram illustrating an overall configuration of a vehicle dispatch management system in the second embodiment of the present disclosure.

The vehicle dispatch management system illustrated in FIG. 23 includes a transportation plan creation server 1A and a plurality of customer terminals 2.

The transportation plan creation server 1A includes a setting data storage part 11A, a provisional transportation plan storage part 12, an unallocated transportation request storage part 13, a transportation request receiver 14A, a transportation plan creator 15, a transmitter 16A, and a real time transportation plan creator 17. Note that, in the second embodiment, the same configuration as that in the first embodiment will be denoted by the same reference sign as that in the first embodiment, and will be omitted from description.

The setting data storage part 11A stores in advance a plurality of pieces of subarea definition data in addition to the bus stop timetable data, the inter-bus stop distance table data, the vehicle definition data, the occupant number constraint data, and the detour degree constraint data.

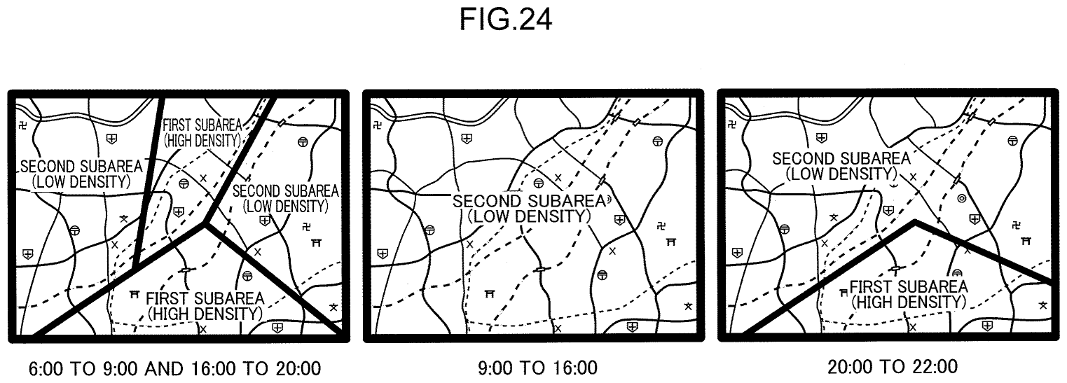

FIG. 24 is a diagram illustrating an example of the plurality of pieces of subarea definition data in the second embodiment.

An area where a plurality of vehicles transports (a business area of a transportation operating company) is divided into at least one subarea. A set of subareas is mutually exclusive and collectively exhaustive (MECE) for the business area. The at least one subarea is classified into a first subarea in which the density of occurrence of transportation requests is higher than a threshold and a second subarea in which the density of occurrence of transportation requests is lower than the threshold. The number of divisions and the size of at least one subarea vary depending on a time period. The plurality of pieces of subarea definition data is provided for each time period.

The setting data storage part 11A stores, for example, first subarea definition data associated with the time period of 6:00 to 9:00 and the time period of 16:00 to 20:00, second subarea definition data associated with the time period of 9:00 to 16:00, and third subarea definition data associated with the time period of 20:00 to 22:00.

In FIG. 24, a high-density first subarea indicates the first subarea in which the density of occurrence of transportation requests is higher than a threshold, and a low-density subarea indicates the second subarea in which the density of occurrence of transportation requests is lower than the threshold. The first subarea definition data defines two first subareas and two second subareas. The second subarea definition data defines one second subarea. The third subarea definition data defines one first subareas and one second subareas.

The transportation request receiver 14A receives the transportation request data transmitted by the customer terminal 2. The transportation request receiver 14A determines whether any one or both of the boarding location and the disembark location included in the transportation request data is in the first subarea or in the second subarea. In a case where any one or both of the boarding location and the disembark location included in the transportation request data are within the first subarea, the transportation request receiver 14A outputs the received transportation request data to the real time transportation plan creator 17. On the other hand, in a case where any one or both of the boarding location and the disembark location included in the transportation request data are within the second subarea, the transportation request receiver 14A stores the received transportation request data in the unallocated transportation request storage part 13.

The real time transportation plan creator 17 immediately creates a transportation plan in which the customer of the transportation request data received by the transportation request receiver 14A is allocated to one vehicle. The real time transportation plan creator 17 creates the transportation plan without considering the profitability of transportation. In a case where any one or both of the boarding location and the disembark location included in the transportation request data are within the first subarea, the real time transportation plan creator 17 immediately creates a transportation plan in which the customer of the transportation request data is allocated to one vehicle on the basis of the transportation request data.

Note that the real time transportation plan creator 17 creates a transportation plan by a method similar to the conventional demand bus service. A conventional transportation plan creating method is disclosed in, for example, a conventional document (Hideyuki Nakashima et al., “Smart Access Vehicle System: Implementation and Evaluation of a Vehicle Operation System for Demand Responsive Public Transportation”, Journal of Information Processing Society of Japan, Vol. 57, No. 4, April 2016, p. 1290-1302).

The transmitter 16A outputs the travel schedule notification information to the customer terminal 2 of the customer allocated to the transportation plan created by the real time transportation plan creator 17. The transmitter 16A outputs the travel schedule notification information to the customer terminal 2 of the customer allocated to the transportation plan created by the real time transportation plan creator 17.

In a case where any one or both of the boarding location and the disembark location included in the transportation request data are in the second subarea, the transportation plan creator 15 creates a provisional transportation plan in which customers of the transportation request data are allocated to a plurality of vehicles such that a predetermined constraint condition is satisfied on the basis of the transportation request data.

Next, the operation of the transportation plan creation server 1A in the second embodiment of the present disclosure will be described.

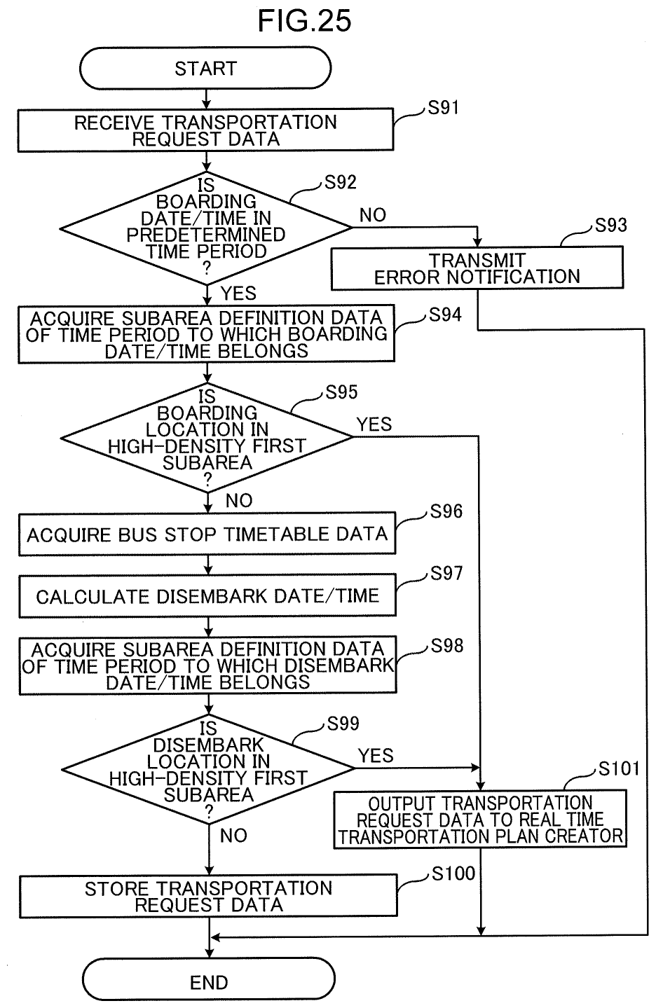

FIG. 25 is a flowchart for describing an operation of the transportation request receiver 14A of the transportation plan creation server 1A in the second embodiment of the present disclosure. Note that the operation illustrated in FIG. 25 is performed with reception of the transportation request data as a trigger.

The processing of Steps S91 to S93 is the same as the processing of Steps S11 to S13 illustrated in FIG. 8, and will be omitted from description.

When it is determined that the boarding date/time is within the predetermined time period (YES in step S92), in step S94, the transportation request receiver 14A acquires the subarea definition data of the time period to which the boarding date/time included in the transportation request data belongs from the setting data storage part 11. For example, when the boarding date/time is 13:00, the transportation request receiver 14A acquires the second subarea definition data in the time period of 9:00 to 16:00.

Next, in step S95, the transportation request receiver 14A determines whether the boarding location included in the transportation request data is in the high-density first subarea on the basis of the acquired subarea definition data.

Here, when it is determined that the boarding location is not in the high-density first subarea, that is, when it is determined that the boarding location is in the low-density second subarea (NO in step S95), the transportation request receiver 14A acquires the bus stop timetable data from the setting data storage part 11 in step S96.

Next, in step S97, the transportation request receiver 14A calculates the disembark date/time in a case where only the customer who has transmitted the transportation request data is transported from the boarding location to the disembark location by using the bus stop timetable data.

When the stop place of the vehicle is not determined in advance and the boarding location and the disembark location are arbitrary places, the transportation request receiver 14A may calculate a transportation route from the boarding location to the disembark location and the transportation time on the basis of map information.

Next, in step S98, the transportation request receiver 14A acquires the subarea definition data of the time period to which the calculated disembark date/time belongs from the setting data storage part 11. For example, when the disembark date/time is 13:30, the transportation request receiver 14A acquires the second subarea definition data in the time period of 9:00 to 16:00.

Next, in step S99, the transportation request receiver 14A determines whether the calculated disembark location is in the high-density first subarea on the basis of the acquired subarea definition data.

Here, when it is determined that the disembark location is not in the high-density first subarea, that is, when it is determined that the disembark location is in the low-density second subarea (NO in step S99), in step S100, the transportation request receiver 14A stores the received transportation request data in the unallocated transportation request storage part 13.

On the other hand, when it is determined in step S95 that the boarding location is in the high-density first subarea (YES in step S95), or when it is determined in step S99 that the disembark location is in the high-density first subarea (YES in step S99), the transportation request receiver 14A outputs the received transportation request data to the real time transportation plan creator 17.

In the second embodiment, when any one of the boarding location or the disembark location included in the transportation request data is in the first subarea, the transportation request receiver 14A outputs the received transportation request data to the real time transportation plan creator 17, but the present disclosure is not limited to this configuration. When only the boarding location included in the transportation request data is in the first subarea, the transportation request receiver 14A may output the received transportation request data to the real time transportation plan creator 17. When only the disembark location included in the transportation request data is in the first subarea, the transportation request receiver 14A may output the received transportation request data to the real time transportation plan creator 17. When both the boarding location and the disembark location included in the transportation request data are in the first subarea, the transportation request receiver 14A may output the received transportation request data to the real time transportation plan creator 17.

The operations of the transportation plan creator 15 and the transmitter 16A in the second embodiment are the same as the operations of the transportation plan creator 15 and the transmitter 16 in the first embodiment, and will be omitted from description.

Note that, in each of the above embodiments, each constituent element may be implemented by including dedicated hardware or by executing a software program suitable for each constituent element. Each constituent element may be implemented by a program execution part, such as a CPU or a processor, reading and executing a software program recorded in a recording medium such as a hard disk or a semiconductor memory. A program may be recorded onto a recording medium and transferred or transferred via a network, so that the program is performed by another independent computer system.

Some or all functions of the device according to the embodiment of the present disclosure are implemented as large scale integration (LSI), which is typically an integrated circuit. These may be individually integrated into one chip, or may be integrated into one chip so as to include some or all of these. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used. Some or all functions of the device according to the embodiments of the present disclosure may be implemented by a processor such as a CPU executing a program.

All numbers used above are illustrated to specifically describe the present disclosure, and the present disclosure is not limited to the illustrated numbers.

The order in which steps illustrated in the above flowchart are executed is for specifically describing the present disclosure, and may be any order other than the above order as long as a similar effect is obtained. Some of the above steps may be executed simultaneously (in parallel) with other steps.

The technology of the present disclosure, which can create a transportation plan capable of securing the profitability of transportation, is useful as a technology for creating a transportation plan for transporting a plurality of customers by a plurality of vehicles.

1. An information processing method in a computer that creates a transportation plan for transporting a plurality of customers by a plurality of vehicles, the method comprising:
acquiring, from a terminal of each of the plurality of customers who desires to be transported by a vehicle, a transportation request including customer identification information, a boarding date/time, a boarding location, and a disembark location;
periodically creating, on a basis of the plurality of transportation requests, a provisional transportation plan in which the plurality of customers is allocated to the plurality of vehicles such that a predetermined constraint condition is satisfied; and
outputting, at a first confirmation date/time for confirming the provisional transportation plan, travel schedule notification information for notifying a terminal of the customer allocated to the provisional transportation plan of a travel schedule from boarding to disembarking of the customer allocated to the provisional transportation plan.

2. The information processing method according to claim 1, further comprising, at a second confirmation date/time for confirming that transportation is impossible, outputting rejection notification information for notifying that transportation is impossible to the terminal of the customer not allocated to the provisional transportation plan.

3. The information processing method according to claim 1, wherein the predetermined constraint condition includes that a number of occupants of each of the plurality of vehicles is equal to or larger than a lower limit value.

4. The information processing method according to claim 3, wherein the lower limit value increases as a transportation distance or a transportation time increases.

5. The information processing method according to claim 3, wherein
the lower limit value is a fixed number of people, and
a transportation fare of the vehicle increases as the transportation distance or the transportation time increases.

6. The information processing method according to claim 1, wherein the predetermined constraint condition includes that a ratio of a total time of individual transportation time for individually transporting a plurality of customers allocated to one vehicle among the plurality of vehicles and an overall transportation time from when the plurality of customers allocated to the one vehicle is first boarded to when the plurality of customers is finally disembarked is equal to or less than a threshold.

7. The information processing method according to claim 1, further comprising, when the provisional transportation plan is created, outputting the adoption notification information for notifying the terminal of each of the plurality of customers allocated to the provisional transportation plan that transportation is possible.

8. The information processing method according to claim 7, further comprising outputting first standby notification information for notifying that a standby time until it is determined whether transportation is possible occurs between acquisition of the transportation request and output of the adoption notification information.

9. The information processing method according to claim 7, further comprising outputting second standby notification information for notifying that a standby time until the travel schedule is determined occurs between output of the adoption notification information and output of the travel schedule notification information.

10. The information processing method according to claim 2, further comprising outputting first standby notification information for notifying that a standby time until it is determined whether transportation is possible occurs between acquisition of the transportation request and output of the rejection notification information.

11. The information processing method according to claim 1, wherein
an area in which the plurality of vehicles transports is divided into at least one subarea, and
the at least one subarea is classified into a first subarea in which a density of occurrence of transportation requests is higher than a threshold and a second subarea in which the density of occurrence of transportation requests is lower than the threshold,
the method further comprising:
in a case where any one or both of the boarding location and the disembark location included in one transportation request among the plurality of transportation requests are in the first subarea, immediately creating a transportation plan in which a customer of the one transportation request is allocated to one vehicle on a basis of the one transportation request; and
outputting the travel schedule notification information to the terminal of the customer allocated to the transportation plan created, wherein
in the creating of the provisional transportation plan, in a case where any one or both of the boarding location and the disembark location included in the one transportation request are in the second subarea, the provisional transportation plan in which the customer of the one transportation request is allocated to the plurality of vehicles is created on a basis of the one transportation request such that the predetermined constraint condition is satisfied.

12. The information processing method according to claim 11, wherein a number of divisions and a size of the at least one subarea vary depending on a time period.

13. An information processing device that creates a transportation plan for transporting a plurality of customers by a plurality of vehicles, the device comprising:
an acquisition part that acquires, from a terminal of each of the plurality of customers who desires to be transported by a vehicle, a transportation request including customer identification information, a boarding date/time, a boarding location, and a disembark location;
a creator that periodically creates, on a basis of the plurality of transportation requests, a provisional transportation plan in which the plurality of customers is allocated to the plurality of vehicles such that a predetermined constraint condition is satisfied; and
an output part that outputs, at a first confirmation date/time for confirming the provisional transportation plan, travel schedule notification information for notifying a terminal of the customer allocated to the provisional transportation plan of a travel schedule from boarding to disembarking of the customer allocated to the provisional transportation plan.

14. A non-transitory computer readable recording medium storing an information processing program that creates a transportation plan for transporting a plurality of customers by a plurality of vehicles, the program causing a computer to function to:
acquire, from a terminal of each of the plurality of customers who desires to be transported by a vehicle, a transportation request including customer identification information, a boarding date/time, a boarding location, and a disembark location;
periodically create, on a basis of the plurality of transportation requests, a provisional transportation plan in which the plurality of customers is allocated to the plurality of vehicles such that a predetermined constraint condition is satisfied; and
output, at a first confirmation date/time for confirming the provisional transportation plan, travel schedule notification information for notifying the terminal of the customer allocated to the provisional transportation plan of a travel schedule from boarding to disembarking of the customer allocated to the provisional transportation plan.
